(19) United States
(12) Patent Application Publication
(10) Pub. No.: US 2026/0120116 A1
(43) Pub. Date: Apr. 30, 2026

(54) EMISSION DATA CALCULATION BASED ON HARMONIZATION OF ECONOMIC SECTORS

(71) Applicant: International Business Machines Corporation, Armonk, NY (US)

(72) Inventors: Shantanu R. Godbole, Bangalore (IN); Jagabondhu Hazra, Bangalore (IN); Manikandan Padmanaban, Chennai (IN); Ayush Jain, Lucknow (IN); Hendrik F. Hamann, Bedford, NY (US); Stephen Foster, Forest Lodge (AU)

(21) Appl. No.: 18/927,068

(22) Filed: Oct. 25, 2024

(51) Int. Cl. G06Q 30/018; G06N 5/02

(52) U.S. Cl. CPC G06Q 30/018; G06N 5/02

(57) ABSTRACT

Harmonization of economic sectors associated with Greenhouse gas (GHG) emission data includes receiving an input and retrieving emission data. The input is associated with a first set of economic sectors and the emission data is associated with a second set of economic sectors. A first set of knowledge graphs is generated based on the first set of economic sectors. A second set of knowledge graphs is generated based on the second set of economic sectors. The first set of economic sectors is harmonized with the second set of economic sectors based on the first set of knowledge graphs and the second set of knowledge graphs. The second emission data is generated based on the harmonization of the first set of economic sectors with the second set of economic sectors. Further, the generated second emission data is rendered.

### BACKGROUND

The disclosure relates to emission data calculation and more particularly, to emission data calculation based on harmonization of economic sectors.

Greenhouse gas emissions are a significant byproduct of various economic sectors (e.g., industrial production, transportation, agriculture, or the like) and significantly contribute to climate change, posing serious environmental and health risks globally. As economies grow, demand for energy and resources increases, thereby leading to higher greenhouse gas emissions. Various organizations categorize greenhouse gas emissions in different scopes for better tracking and management. Scope 1 emissions correspond to direct greenhouse gas emissions from owned or controlled sources of the organizations (e.g., company vehicles, manufacturing facilities, and the like). Further, scope 2 emissions correspond to indirect greenhouse gas emissions associated with the purchase of electricity, steam, heat, or cooling used by the organizations. Additionally, scope 3 emissions correspond to the greenhouse gas emissions that are a result of activities not owned or directly controlled by the organizations (e.g., extraction of raw material, transportation of raw material, end-of-life disposal, and the like). Further, the calculation of the scope 3 emissions involves multiple stakeholders and consideration of indirect activities, thereby making the calculations resource-intensive, cumbersome, as well as time-consuming. Thus, the calculation of the scope 3 emissions poses a significant challenge for the organizations.

### SUMMARY

According to an embodiment of the disclosure, a computer-implemented method for emission data calculation based on harmonization of economic sectors is described. The computer-implemented method includes receiving, by a computer, a first input including a first set of economic sectors in a geographical region. The computer-implemented method further includes retrieving, by the computer, first emission data associated with the second set of economic sectors. The first emission data indicates an emission of a set of pollutants by each economic sector of the second set of economic sectors. Further, the first emission data is retrieved from one or more databases. The computer-implemented method further includes generating, by the computer, a first set of knowledge graphs based on the first set of economic sectors. The computer-implemented method further includes generating, by the computer, a second set of knowledge graphs based on the second set of economic sectors. The computer-implemented method further includes harmonizing, by the computer, the first set of economic sectors with the second set of economic sectors based on the first set of knowledge graphs and the second set of knowledge graphs. The computer-implemented method further includes generating, by the computer, second emission data based on the harmonization of the first set of economic sectors with the second set of economic sectors. The generated second emission data is indicative of harmonized emission data of the second set of economic sectors. The computer-implemented method further includes rendering, by the computer, the generated second emission data.

According to one or more embodiments of the disclosure, a computer system is described. The computer system includes a processor set, one or more computer-readable storage media, and program instructions stored on the one or more computer-readable storage media. The program instructions executable by the processor set to cause the processor set to perform a method for emission data calculation based on the harmonization of the economic sectors. The method includes receiving a first input including a first set of economic sectors in a geographical region. The method further includes retrieving first emission data associated with the second set of economic sectors. The first emission data indicates an emission of a set of pollutants by each economic sector of the second set of economic sectors. Further, the first emission data is retrieved from one or more databases. The method further includes generating a first set of embedding vectors based on the reception of the first input. The method further includes generating a second set of embedding vectors based on the retrieval of the first emission data input. The method further includes harmonizing the first set of economic sectors with the second set of economic sectors based on the first set of embedding vectors and the second set of embedding vectors. The method further includes generating second emission data based on the harmonization of the first set of economic sectors with the second set of economic sectors. The generated second emission data is indicative of harmonized emission data of the second set of economic sectors. The method further includes rendering the generated second emission data.

According to one or more embodiments of the disclosure, a computer-program product is described. The computer-program product includes one or more computer-readable storage media and program instructions stored on the one or more computer-readable storage media to perform operations including receiving a first input including a first set of economic sectors in a geographical region. The program instructions further include retrieving first emission data associated with the second set of economic sectors. The first emission data indicates an emission of a set of pollutants by each economic sector of the second set of economic sectors. The first emission data is retrieved from one or more databases. The program instructions further include generating a first set of knowledge graphs based on the first set of economic sectors. The program instructions further include generating a second set of knowledge graphs based on the second set of economic sectors. The program instructions further include harmonizing the first set of economic sectors with the second set of economic sectors based on the first set of knowledge graphs and the second set of knowledge graphs. The program instructions further include generating second emission data based on the harmonization of the first set of economic sectors with the second set of economic sectors. The generated second emission data is indicative of harmonized emission data of the second set of economic sectors. The program instructions further include rendering the generated second emission data.

Additional technical features and benefits are realized through the techniques of the disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The following description will provide details of preferred embodiments with reference to the following figures wherein:

FIG. 1 is a diagram that illustrates a computing environment for emission data calculation based on harmonization of economic sectors, in accordance with an embodiment of the disclosure;

FIG. 2 is a diagram that illustrates an environment for calculation of the emission data based on the harmonization of the economic sectors, in accordance with an embodiment of the disclosure;

FIG. 3 is a diagram that illustrates exemplary operations for determining one or more missing values in the emission data and calculating the emission data based on the harmonization of the economic sectors, in accordance with an embodiment of the disclosure;

FIG. 4 is a diagram that illustrates exemplary operations for determining one or more missing values in the emission data, in accordance with an embodiment of the disclosure;

FIG. 5 is a diagram that illustrates exemplary operations for calculating the emission data based on the harmonization of the economic sectors, in accordance with an embodiment of the disclosure;

FIGS. 6A and 6B are diagrams that collectively illustrate a flowchart of an exemplary method for computation of the missing emission data, in accordance with an embodiment of the disclosure; and

FIG. 7 is a diagram that illustrates a flowchart of an exemplary method for calculation of the emission data based on harmonization of the economic sectors, in accordance with an embodiment of the disclosure.

### DETAILED DESCRIPTION

Greenhouse gas (GHG) emissions are a substantial byproduct of diverse economic activities, such as industrial manufacturing, transportation networks, agricultural practices, and various other activities. The GHG emissions significantly contribute to the escalating global climate crisis, posing grave environmental hazards and health risks worldwide. As economies continue to expand and develop, the demand for energy and resources inevitably rises, which in turn leads to an increase in the GHG emissions into the atmosphere. The GHG emissions are classified into scope 1 emissions, scope 2 emissions, and scope 3 emissions under the GHG Protocol. Generally, the scope 1 emissions correspond to direct greenhouse gas emissions from one or more sources that are owned or controlled by the organizations (e.g., company vehicles, manufacturing facilities, and the like). Further, the scope 2 emissions correspond to indirect greenhouse gas emissions associated with the purchase of electricity, steam, heat, or cooling used by the organizations. The scope 3 emissions refer to all indirect emissions that occur in a value chain of an organization including both upstream (e.g., sourcing, extracting, or the like) and downstream activities (e.g., distribution, sales, end-of-life disposal, or the like).

The scope 3 emissions are significantly complex to calculate and evaluate due to the broad coverage of indirect activities across the entire value chain of the organization. Additionally, data availability and transparency are often limited. Several organizations provide different frameworks for categorizing and calculating the scope 3 emissions, leading to challenges in standardization across industries. The scope 3 emissions are calculated based on spend-based emission factors that associate financial expenditure with average emissions per dollar across different economic sectors using input-output models from different organizations such as the World Input-Output Table (WIOT), the Organization for Economic Cooperation and Development (OECD), or the like. Further, calculation of the scope 3 emissions often requires external data sources to account for the emissions across complex value chains. Several databases and modeling tools are commonly used to provide data inputs for the scope 3 emissions, each with a different methodology and coverage that further leads to inconsistency.

To address these issues, there is a need for a system that can harmonize different sets of economic sectors associated with the GHG emissions globally. Such a system may leverage machine learning models and natural language processing to provide emission data calculation based on the harmonization of the different sets of economic sectors.

The disclosed system is configured to receive a first input including the first set of economic sectors in a geographical region. Further, the system is configured to retrieve first emission data associated with a second set of economic sectors that may correspond to the different sets of economic sectors. The proposed system aims to harmonize the first set of economic sectors that may correspond to a standardized version of the second set of economic sectors. Further, the proposed system aims to compute missing emission data associated with the first emission data. Upon computing the missing emission data, the proposed system aims to generate second emission data such that the generated second emission data may be associated with harmonized emission data associated with the second set of economic sectors. The generated second emission data may bring uniformity to the spend-based emission factors for scope 3 computation.

The core components of the disclosed system utilize machine learning algorithms to identify missing data (e.g., one or more missing values) in the first emission data. By identifying the missing data, the disclosed system is configured to initiate determination of a set of clusters associated with at least one of a geographical region, a time period, and a subset of economic sectors of the plurality of emission categories with identical emission data. Upon determining the set of clusters, the system determines the missing data.

The disclosed system is further configured to harmonize the first set of economic sectors with the second set of economic sectors. By harmonizing the first set of economic sectors, the system provides uniformity for calculating the scope 3 emissions. Upon harmonizing the first set of economic sectors, the system is further configured to generate second emission data indicative of an emission of the set of pollutants by each sector of the first set of economic sectors.

According to an embodiment of the disclosure, a computer-implemented method for emission data calculation based on harmonization of economic sectors is described. The computer-implemented method includes receiving, by a computer, a first input including a first set of economic sectors in a geographical region. The computer-implemented method further includes retrieving, by the computer, first emission data associated with the second set of economic sectors. The first emission data indicates an emission of a set of pollutants by each economic sector of the second set of economic sectors. Further, the first emission data is retrieved from one or more databases. The computer-implemented method further includes generating, by the computer, a first set of knowledge graphs based on the first set of economic sectors. The computer-implemented method further includes generating, by the computer, a second set of knowledge graphs based on the second set of economic sectors. The computer-implemented method further includes harmonizing, by the computer, the first set of economic sectors with the second set of economic sectors based on the first set of knowledge graphs and the second set of knowledge graphs. The computer-implemented method further includes generating, by the computer, second emission data based on the harmonization of the first set of economic sectors with the second set of economic sectors. The generated second emission data is indicative of harmonized emission data of the second set of economic sectors. The computer-implemented method further includes rendering, by the computer, the generated second emission data.

In other embodiments of the disclosure, one or more economic sectors of the first set of economic sectors correspond to an economic sector of the second set of economic sectors.

In other embodiments of the disclosure, one or more economic sectors of the second set of economic sectors correspond to an economic sector of the first set of economic sectors.

In other embodiments of the disclosure, the computer-implemented method further includes identifying, by the computer, one or more missing values in a first emission table based on the retrieval of the first emission data. The first emission data includes the first emission table. The computer-implemented method further includes determining, by the computer, a set of clusters based on the identification of the one or more missing values. Each cluster of the set of clusters is associated with at least one of the geographical region, a time period, or a subset of economic sectors of the second set of economic sectors. The computer-implemented method further includes determining, by the computer, the one or more missing values based on the set of clusters.

In other embodiments of the disclosure, the computer-implemented method further includes generating, by the computer, a set of graph data structures based on the determined set of clusters. The computer-implemented method further includes generating, by the computer, a graph embedding vector for each graph data structure of the set of graph data structures.

In other embodiments of the disclosure, the computer-implemented method further includes retrieving, by the computer, contextual data associated with the second set of economic sectors in the geographical region. The computer-implemented method further includes determining, by the computer, a feature representation for each graph data structure of the set of graph data structures based on the contextual data and the set of clusters. The computer-implemented method further includes tuning, by the computer, a graph-based foundation model based on the determined feature representation for each graph data structure of the set of graph data structures and the generated graph embedding vector for each graph data structure of the set of graph data structures. The graph-based foundation model analyzes at least one of a spatial relationship, a temporal relationship, or a sectoral relationship of the set of pollutants by each economic sector of the second set of economic sectors. The computer-implemented method further includes determining, by the computer, the one or more missing values in the first emission table based on the tuning of the graph-based foundation model.

In other embodiments of the disclosure, the contextual data includes at least one of economic indicator data of the geographical region, demographic indicator data of the geographical region, or social indicator data of the geographical region.

In other embodiments of the disclosure, the computer-implemented method further includes extracting, by the computer, a set of features from the first emission data based on the identification of the one or more missing values. The set of features includes at least one of spatial features, temporal features, or sectoral features associated with each economic sector of the second set of economic sectors. The computer-implemented method further includes determining, by the computer, the set of clusters based on the extracted set of features.

In other embodiments of the disclosure, the computer-implemented method further includes generating, by the computer, a first set of embedding vectors based on the first set of knowledge graphs. The computer-implemented method further includes generating, by the computer, a second set of embedding vectors based on the second set of knowledge graphs. The computer-implemented method further includes harmonizing, by the computer, the first set of economic sectors with the second set of economic sectors based on the first set of embedding vectors and the second set of embedding vectors.

In other embodiments of the disclosure, the computer-implemented method further includes aggregating, by the computer, the first set of embedding vectors and the second set of embedding vectors. The computer-implemented method further includes generating, by the computer, a third set of embedding vectors based on the aggregation of the first set of embedding vectors and the second set of embedding vectors. The computer-implemented method further includes disaggregating, by the computer, the third set of embedding vectors. The computer-implemented method further includes generating, by the computer, a fourth set of embedding vectors based on the disaggregation of the third set of embedding vectors. The computer-implemented method further includes harmonizing, by the computer, the first set of economic sectors with the second set of economic sectors based on the generated fourth set of embedding vectors.

In other embodiments of the disclosure, the computer-implemented method further includes determining, by the computer, a first economic sector of the first set of economic sectors is unharmonized with at least one economic sector of the second set of economic sectors. The computer-implemented method further includes executing, by the computer, a reverse mapping of the first economic sector with the at least one economic sector based on the determination that the first economic sector is unharmonized with the at least one economic sector of the second set of economic sectors. The computer-implemented method further includes harmonizing, by the computer, the first economic sector with the at least one economic sector of the second set of economic sectors based on the reverse mapping. The computer-implemented method further includes generating, by the computer, the second emission data based on the harmonization of the first economic sectors with the at least one economic sector of the second set of economic sectors.

In other embodiments of the disclosure, the computer-implemented method further includes receiving, by the computer, input-output data associated with the geographical region. The input-output data includes at least one of resource input information, output production information, or inter-industry exchange information associated with each economic sector of the second set of economic sectors. The computer-implemented method further includes generating, by the computer, the second emission data based on the input-output data associated with the geographical region and the harmonization of the first set of economic sectors with the second set of economic sectors.

In other embodiments of the disclosure, the computer-implemented method further includes generating, by the computer, the first set of knowledge graphs based on an application of one or more natural language processing (NLP) techniques on the first input.

According to one or more embodiments of the disclosure, a computer system is described. The computer system includes a processor set, one or more computer-readable storage media, and program instructions stored on the one or more computer-readable storage media. The program instructions executable by the processor set to cause the processor set to perform a method for emission data calculation based on the harmonization of the economic sectors. The method includes receiving a first input including a first set of economic sectors in a geographical region. The method further includes retrieving first emission data associated with the second set of economic sectors. The first emission data indicates an emission of a set of pollutants by each economic sector of the second set of economic sectors. Further, the first emission data is retrieved from one or more databases. The method further includes generating a first set of embedding vectors based on the reception of the first input. The method further includes generating a second set of embedding vectors based on the retrieval of the first emission data input. The method further includes harmonizing the first set of economic sectors with the second set of economic sectors based on the first set of embedding vectors and the second set of embedding vectors. The method further includes generating second emission data based on the harmonization of the first set of economic sectors with the second set of economic sectors. The generated second emission data is indicative of harmonized emission data of the second set of economic sectors. The method further includes rendering the generated second emission data.

In other embodiments of the disclosure, the program instructions further include identifying one or more missing values in a first emission table based on the retrieval of the first emission data. The first emission data includes the first emission table. The program instructions further include determining a set of clusters based on the identification of the one or more missing values. Each cluster of the set of clusters is associated with at least one of the geographical region, a time period, or a subset of economic sectors of the second set of economic sectors. The program instructions further include determining the one or more missing values based on the set of clusters.

In other embodiments of the disclosure, the program instructions further include generating a set of graph data structures based on the set of clusters. The program instructions further include generating a graph embedding vector for each graph data structure of the set of graph data structures.

In other embodiments of the disclosure, the program instructions further include retrieving contextual data associated with the second set of economic sectors in the geographical region. The program instructions further include determining a feature representation for each graph data structure of the set of graph data structures based on the contextual data and the set of clusters. The program instructions further include tuning a graph-based foundation model based on the determined feature representation for each graph data structure of the set of graph data structures and the generated graph embedding vector for each graph data structure of the set of graph data structures. The graph-based foundation model analyzes at least one of a spatial relationship, a temporal relationship, or a sectoral relationship of the set of pollutants by each economic sector of the second set of economic sectors. The program instructions further include determining the one or more missing values in the first emission table based on the tuned graph-based foundation model.

In other embodiments of the disclosure, the program instructions further include generating a first set of knowledge graphs based on the first set of economic sectors. The program instructions further include generating the first set of embedding vectors based on the first set of knowledge graphs. The program instructions further include generating a second set of knowledge graphs based on the second set of economic sectors. The program instructions further include generating the second set of embedding vectors based on the second set of knowledge graphs.

In other embodiments of the disclosure, the program instructions further include aggregating the first set of embedding vectors and the second set of embedding vectors. The program instructions further include generating a third set of embedding vectors based on the aggregation of the first set of embedding vectors and the second set of embedding vectors. The program instructions further include disaggregating the third set of embedding vectors. The program instructions further include generating a fourth set of embedding vectors based on the disaggregation of the third set of embedding vectors. The program instructions further include harmonizing the first set of economic sectors with the second set of economic sectors based on the generated fourth set of embedding vectors.

According to one or more embodiments of the disclosure, a computer-program product is described. The computer-program product includes one or more computer-readable storage media and program instructions stored on the one or more computer-readable storage media to perform operations including receiving a first input including a first set of economic sectors in a geographical region. The program instructions further include retrieving first emission data associated with the second set of economic sectors. The first emission data indicates an emission of a set of pollutants by each economic sector of the second set of economic sectors. The first emission data is retrieved from one or more databases. The program instructions further include generating a first set of knowledge graphs based on the first set of economic sectors. The program instructions further include generating a second set of knowledge graphs based on the second set of economic sectors. The program instructions further include harmonizing the first set of economic sectors with the second set of economic sectors based on the first set of knowledge graphs and the second set of knowledge graphs. The program instructions further include generating second emission data based on the harmonization of the first set of economic sectors with the second set of economic sectors. The generated second emission data is indicative of harmonized emission data of the second set of economic sectors. The program instructions further include rendering the generated second emission data.

Various aspects of the disclosure are described by narrative text, flowcharts, block diagrams of computer systems and/or block diagrams of the machine logic included in computer-program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated operation, concurrently, or in a manner at least partially overlapping in time.

A computer-program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

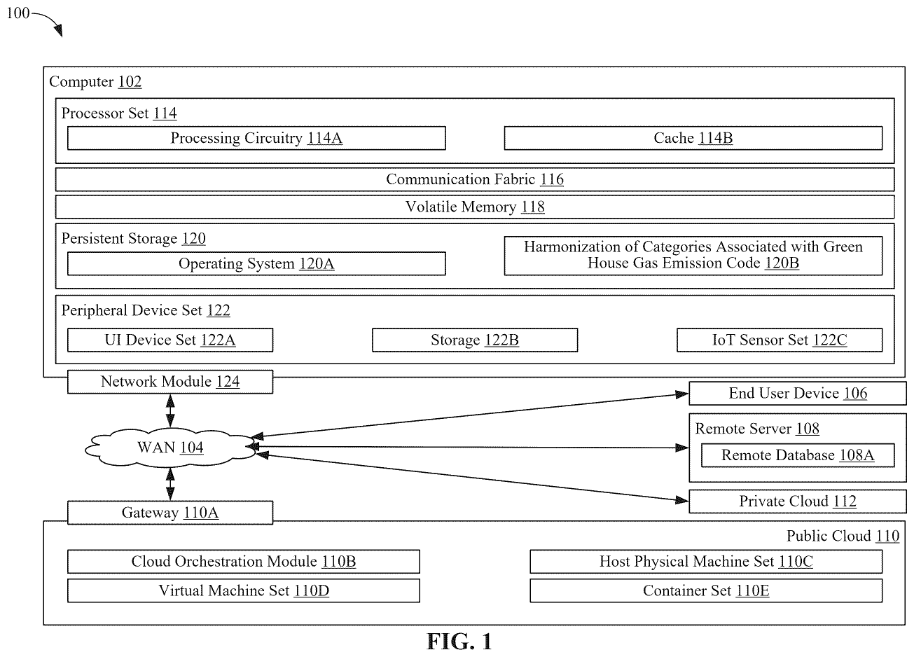

FIG. 1 is a diagram that illustrates a computing environment for emission data calculation based on harmonization of economic sectors, in accordance with an embodiment of the disclosure. With reference to FIG. 1, there is shown a computing environment 100 that contains an example of an environment for the execution of at least some of the computer code involved in performing the disclosed methods, such as harmonization of categories associated with greenhouse gas emissions code 120B. In addition to the harmonization of categories associated with greenhouse gas emissions code 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the harmonization of categories associated with greenhouse gas emissions code 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or other wearable computer, a mainframe computer, a quantum computer, or any other form of a computer or a mobile device now known or to be developed in the future that is capable of running a program, accessing a network or querying a database, such as a remote database 130. As is well understood in the art of computer technology, and depending upon the technology, the performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, computer 102 is not required to be in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the other storage media discussed below. The program instructions, and associated data, are accessed by the processor set 114 to control and direct the performance of the disclosed methods. In computing environment 100, at least some of the instructions for performing the disclosed methods may be stored in the dynamic modification of the harmonization of categories associated with greenhouse gas emissions code 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not required unless affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 may be a read-only memory (ROM), but typically at least a portion of the persistent storage 120 allows writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the harmonization of categories associated with greenhouse gas emissions code 120B typically includes at least some of the computer code involved in performing the disclosed methods.

The peripheral device set 122 includes the set of peripheral devices of computer 102. Data communication connections between the peripheral devices and the other components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In some embodiments of the disclosure, storage 122B may take the form of a quantum computing storage device for storing data in the form of qubits. In embodiments of the disclosure where computer 102 is required to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, one sensor may be a thermometer, and another sensor may be a motion detector.

The network module 124 is the collection of computer software, hardware, and firmware that allows computer 102 to communicate with other computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In other embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 130 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer-program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in other embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

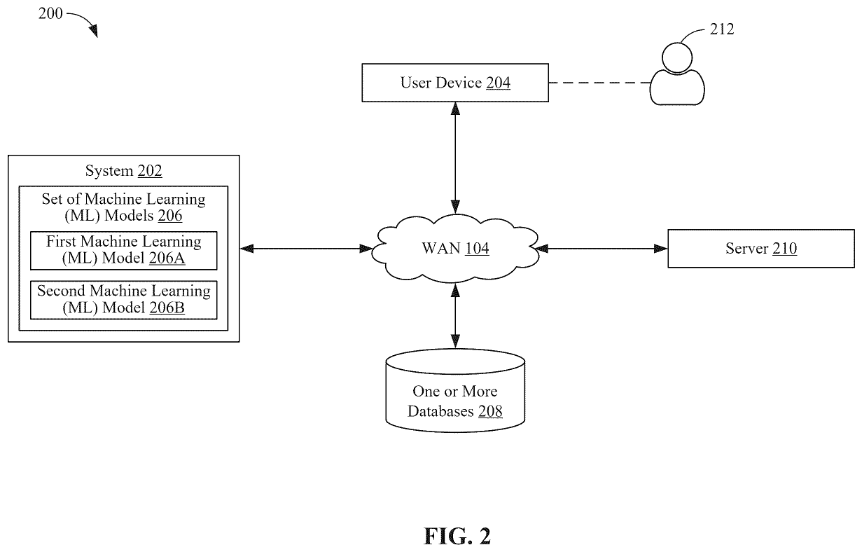

FIG. 2 is a diagram that illustrates an environment for calculation of the emission data based on the harmonization of the economic sectors, in accordance with an embodiment of the disclosure. FIG. 2 is explained in conjunction with elements from FIG. 1. With reference to FIG. 2, there is shown a diagram of a network environment 200. The network environment 200 includes a system 202 and a user device 204. The system 202 includes a set of machine learning (ML) models 206. The network environment 200 further includes one or more databases 208, a server 210, and a user 212 associated with the user device 204. The network environment 200 further includes the WAN 104 of FIG. 1. In an embodiment of the disclosure, the system 202 may be an exemplary embodiment of the computer 102 of FIG. 1.

The system 202 may include suitable logic, circuitry, interfaces, and/or code that may be configured for calculation of the emission data based on the harmonization of a first set of economic sectors in a geographical region with a second set of economic sectors in the geographical region. In an embodiment, the first set of economic sectors may be associated with the second set of economic sectors. The system 202 may be configured to receive a first input including the first set of economic sectors. Examples of the first set of economic sectors may include, but are not limited to, power generation, maritime transport, construction, and waste management. The system 202 may be further configured to retrieve first emission data associated with the second set of economic sectors. The first emission data indicates an emission of a set of pollutants by each economic sector of the second set of economic sectors. Examples of the second set of economic sectors may include, but are not limited to, agriculture, forestry, fishing, manufacturing, mining, quarrying, energy production and distribution, or the like. Examples of the set of pollutants may include, but are not limited to, Carbon Dioxide (CO₂), Methane (CH₄), Nitrous Oxide (N₂O), Ozone (O₃), or the like.

In an embodiment, the second set of economic sectors may correspond to a diverse collection of classifications employed across different databases or regions to categorize the first emission data (e.g., greenhouse gas (GHG) emissions). The second set of economic sectors may represent various economic sectors such as agriculture, mining, fishing, textile, or the like. In an embodiment, such economic sectors may be categorized based on country-specific standards, international classification schemas, various organizations, or the like. Examples of commonly used classification systems include the United States Environmentally Extended Input-Output (USEEIO) model, the Organization for Economic Co-operation and Development (OECD) model, the International Standard Industrial Classification of All Economic Activities (ISIC), and the like. Each classification system may define the various sectors in different ways. For example, USEEIO may categorize economic sectors such as textile and manufacturing differently from ISIC. Thus, such differences in structure and granularity associated with the various economic sectors may create challenges during aggregation and data analysis across multiple sources.

The first set of economic sectors may correspond to a predefined set of sectors that may be standardized to streamline the classification of various economic sectors. The first set of economic sectors may represent various economic sectors such as power generation, maritime transport, construction, waste management, and the like that may be based on established sectoral frameworks or other international standards such that the first set of economic sectors may be predefined.

In an embodiment, the harmonization of the first set of economic sectors with the second set of economic sectors may refer to aligning and comparing each economic sector of the first set of economic sectors with at least one economic sector of the second set of economic sectors. Based on the alignment and the comparison, the system 202 may identify a mapping between each economic sector of the first set of economic sectors with at least one economic sector of the second set of economic sectors. The mapping may correspond to one-to-one mapping, where an economic sector of the first set of economic sectors may directly correspond to an economic sector of the second set of economic sectors. In various embodiments of the disclosure, the mapping may correspond to many-to-one mapping, where two or more economic sectors of the first set of economic sectors may correspond to an economic sector of the second set of economic sectors. Additionally, the mapping may correspond to one-to-many mapping, where an economic sector of the first set of economic sectors may correspond to two or more economic sectors of the second set of economic sectors. For example, the second set of economic sectors may include 100 economic sectors, and the first set of economic sectors may include 66 economic sectors. The system 202 may harmonize the first set of economic sectors with the second set of economic sectors such that a mapping between the 66 economic sectors and the 100 economic sectors may be identified.

The system 202 may be further configured to provide the first emission data and the first input, as an input, to a first ML model 206A of the set of ML models 206. The system 202 may be further configured to receive second emission data that may be indicative of harmonized emission data of the second set of economic sectors, as an output, of the first ML model 206A. In an embodiment, the harmonized emission data of the second set of economic sectors may correspond to emission data that may be aligned across various economic sectors of the first set of economic sectors based on the mapping between each economic sector of the first set of economic sectors with at least one economic sector of the second set of economic sectors. For example, when the first emission data may be associated with the 100 economic sectors, the second emission data (or the harmonized emission data of the second set of economic sectors) may be associated with 66 economic sectors.

The system 202 may be further configured to render the received second emission data. Examples of rendering of the received second emission data may correspond to converting the received second emission data into a visual representation, storage of the received second emission data, and transforming the received second emission data into a graphical interface, such as a chart, a map, or the like. Examples of the system 202 may include, but are not limited to, a server, a computing device, a virtual computing device, a mainframe machine, a computer workstation, a smartphone, a cellular phone, a mobile phone, a gaming device, or a consumer electronic (CE) device.

The user device 204 may include suitable logic, circuitry, interfaces, and/or code that may be configured to receive the first input from the user 212 and transmit the received first input to the system 202. The user device 204 may include a display screen. In an embodiment, the user device 204 may be further configured to render the second emission data received from the system 202 on the display screen associated with the user device 204. In an embodiment, the user 212 may correspond to a stand-alone user or an organization. Examples of the user device 204 may include, but are not limited to, a computing device, a mainframe machine, a server, a computer workstation, a smartphone, a cellular phone, a mobile phone, a gaming device, a consumer electronic (CE) device, a head-mounted device, a Virtual Reality (VR) Headset, an Augmented Reality (AR) Device, a Mixed Reality (MR) Device, a Projection-based System, and/or any other device with computer vision display capabilities.

The display screen may include suitable logic, circuitry, and interfaces that may be configured to render the received second emission data. In an embodiment of the disclosure, the display screen may be an external display device associated with the user device 204. The display screen may be a touch screen which may enable the user 212 to provide the first input via the display screen. The touch screen may be at least one of a resistive touch screen, a capacitive touch screen, or a thermal touch screen. In accordance with an embodiment of the disclosure, the display screen may refer to a display screen of a head-mounted device (HMD), a smart-glass device, a see-through display, a projection-based display, an electro-chromic display, or a transparent display. In some embodiments of the disclosure, the display screen may be realized through several known technologies such as, but are not limited to, at least one of a Liquid Crystal Display (LCD) display, a Light Emitting Diode (LED) display, a plasma display, or an Organic LED (OLED) display technology, or other display devices.

The first ML model 206A may be a computational network or a system of artificial neurons, arranged in a plurality of layers, as nodes. The plurality of layers of the first ML model 206A may include an input layer, one or more hidden layers, and an output layer. Each layer of the plurality of layers may include one or more nodes (or artificial neurons). Outputs of all nodes in the input layer may be coupled to at least one node of the hidden layer(s). Similarly, inputs of each hidden layer may be coupled to outputs of at least one node in other layers of the first ML model 206A. Outputs of each hidden layer may be coupled to inputs of at least one node in other layers of the first ML model 206A. Node(s) in the final layer may receive inputs from at least one hidden layer to output a result. The number of layers and the number of nodes in each layer may be determined from hyper-parameters of the first ML model 206A. Such hyper-parameters may be set before or while training the first ML model 206A on a training dataset.

Each node of the first ML model 206A may correspond to a mathematical function (e.g., a sigmoid function or a rectified linear unit) with a set of parameters, tunable during the training of the network. The set of parameters may include, for example, a weight parameter, a regularization parameter, and the like. Each node may use the mathematical function to compute an output based on one or more inputs from nodes in other layer(s) (e.g., previous layer(s)) of the first ML model 206A. All or some of the nodes of the first ML model 206A may correspond to the same or a different mathematical function.

During the training of the first ML model 206A, one or more parameters of each node of the first ML model 206A may be updated based on whether an output of the final layer for a given input (from the training dataset) matches a correct result based on a loss function for the first ML model 206A. The above process may be repeated for the same or a different input until a minima of loss function may be achieved, and a training error may be minimized. Several methods for training are known in the art, for example, gradient descent, stochastic gradient descent, batch gradient descent, gradient boost, meta-heuristics, and the like.

The first ML model 206A may include electronic data, such as, for example, a software program, code of the software program, libraries, applications, scripts, or other logic or instructions for execution by a processing device, such as a processor set. The first ML model 206A may include code and routines configured to enable a computing device, such as the system 202, to perform one or more operations. Additionally, or alternatively, the first ML model 206A may be implemented using hardware including a processor, a microprocessor (e.g., to perform or control the performance of one or more operations), a field-programmable gate array (FPGA), or an application-specific integrated circuit (ASIC). Alternatively, in some embodiments, the first ML model 206A may be implemented using a combination of hardware and software. Although in FIG. 2, the first ML model 206A is shown as a separate entity from the system 202, the disclosure is not so limited. Accordingly, in some embodiments, the first ML model 206A may be integrated within the system 202, without deviation from the scope of the disclosure. In an embodiment, the first ML model 206A may be stored in the server 210. Examples of the first ML model 206A may include, but are not limited to, a deep neural network (DNN), a convolutional neural network (CNN), a CNN-recurrent neural network (CNN-RNN), an artificial neural network (ANN), a fully connected neural network, and/or a combination of such networks.

In an embodiment, a second ML model 206B of the set of ML models 206 may correspond to a computer-based system or software that exhibits characteristics commonly associated with human intelligence. The second ML model 206B may be designed to perform tasks that typically require human intelligence, such as problem-solving, learning, reasoning, perception, understanding natural language, and decision-making. AI systems can range from simple rule-based programs to sophisticated, self-learning systems.

The second ML model 206B may be a sophisticated piece of software that leverages natural language processing (NLP) and machine learning techniques to understand, generate, and manipulate human language. For example, the second ML model 206B may correspond to a language model or a large language model (LLM) model that is specifically designed for tasks related to language understanding and generation on a large scale. Certain characteristics of the LLM model may include, but are not limited to, natural language understanding, text generation, semantic understanding, transfer learning, multimodal capabilities, continuous learning, and user interaction. For example, the LLM model for language processing may be implemented using GPT, Bidirectional Encoder Representations from Transformers (BERT), and the like.

Further, the LLM may be a type of ML model specifically designed to understand, generate, and manipulate human language on a large scale. LLMs may leverage machine learning techniques, particularly those based on deep learning architectures, to process and comprehend natural language. LLMs have gained prominence for their ability to perform a wide range of language-related tasks, including natural language understanding, text generation, translation, summarization, and more. Typically, LLMs may be characterized by a vast number of parameters, often ranging from tens of millions to billions. The large parameter count allows these models to capture complex language patterns and relationships during training.

For example, the LLMs may be considered to be built on Transformer architecture, however, this should not be construed as a limitation. For example, the transformer architecture effectively captures long-range dependencies and contextual information in language. Moreover, the transformer architecture may use attention mechanisms to weigh the significance of different parts of an input sequence. In addition, the LLMs may employ bidirectional processing, allowing the models to consider context from both directions when analyzing a sequence of words. This bidirectional approach enhances the model's understanding of the context in which words appear. For example, the LLMs may generate contextual representations of words, meaning that the representation of a word is influenced by its surrounding context. This enables the model to capture the meaning of words in different contexts.

Recently, the use of LLMs has increased manifold for a variety of language-related tasks, such as sentiment analysis, text classification, question answering, machine translation, summarization, and conversational agents. Due to a large number of parameters, training of LLMs from scratch is a time-consuming and expensive process, and therefore, not preferable. To address this problem, pre-trained LLMs are used for generic tasks. For example, LLMs are typically pre-trained on extensive and diverse datasets containing a wide variety of text from the internet. Pre-training involves exposing the model to a broad range of language patterns, allowing it to learn general linguistic features. However, for performing domain-specific tasks, adaptation of LLMs for the particular domain needs to be performed. In one example, LLMs may leverage transfer learning where the model is pre-trained on a large corpus of data and then fine-tuned for specific tasks or domains. This approach enables the model to transfer the knowledge gained during pre-training to various downstream applications.

It may be noted that a base model in an LLM refers to a pre-trained model that has been trained on a large corpus of data for a general natural language understanding and generation task. The pre-trained model serves as a foundation for capturing broad linguistic patterns and knowledge from diverse sources. For example, in the context of pre-trained transformers, a base model is pre-trained on a massive dataset to predict the next word in a sequence, effectively learning grammar, context, and semantics from diverse language patterns.

For example, the base model contains a large number of parameters and exhibits a high level of language understanding, making it a powerful starting point for a variety of natural language processing tasks. While the base model is pre-trained on a large corpus of general language data, fine-tuning or adapting the base model for specific tasks or domains enhances its performance and makes it more suitable for targeted applications.

Continuing further, an adapter refers to a smaller and task-specific module added to the base model to adapt the base model for a particular task or domain. The adapter includes a lightweight set of parameters that is trained on task-specific data while keeping all or the majority of the base model's parameters frozen. In particular, the adapter is used to fine-tune the base model for a specific downstream task without extensively modifying its pre-trained parameters. This approach is beneficial when computational resources or labeled task-specific data are limited.

The one or more databases 208 may correspond to an organized collection of data that may be stored and accessed electronically from a computer system (such as the system 202). In an embodiment, the one or more databases 208 may store economic sector classifications, economic data, environmental input-output models, or the like. In an embodiment, the one or more databases 208 may be configured to receive the first emission data from various international emission databases Examples of the international emission databases may correspond to databases associated with USEEIO, the OECD model, the ISIC, EXIOBASE, or the like. Additionally, the one or more databases 208 may be configured to receive contextual data associated with the second set of economic sectors from various economic and statistical organizations such as the Bureau of Economic Analysis (BEA), Eurostat, World Bank, Office for National Statistics (ONS), or the like. In an embodiment, the contextual data may correspond to at least one of economic indicator information of the geographical region, demographic indicator information of the geographical region, social indicator information of the geographical region, or the like. The one or more databases 208 may be further configured to store the first emission data and the contextual data.

The one or more databases 208 may be designed to manage, store, retrieve, and update emission data (e.g., the first emission data and the second emission data) efficiently. The structure of the one or more databases 208 typically involves tables, records, and fields that can be managed through various database management systems (DBMS). Examples of the one or more databases 208 may include, but are not limited to, a relational database, a Non-Structured Query Language (NoSQL) database, a hierarchical database, a network database, a transactional database, a data warehouse, a distributed database, or the like.

The server 210 may include suitable logic, circuitry, and interfaces, and/or code that may be configured to receive the first input from the user device 204. Upon receiving the first input, the server 210 may be further configured to store the first input. In an embodiment, the server 210 may be configured to store the first ML model 206A and the second ML model 206B. The server 210 may be implemented as a cloud server and may execute operations through web applications, cloud applications, HTTP requests, repository operations, file transfer, and the like. Other example implementations of the server 210 may include, but are not limited to, a database server, a file server, a web server, a media server, an application server, a mainframe server, or a cloud computing server.

In an embodiment of the disclosure, the server 210 may be implemented as a plurality of distributed cloud-based resources by use of several technologies that are well known to those ordinarily skilled in the art. A person with ordinary skill in the art will understand that the scope of the disclosure may not be limited to the implementation of the server 210 and the system 202 as two separate entities. In certain embodiments, the functionalities of the server 210 can be incorporated in its entirety or at least partially in the system 202, without a departure from the scope of the disclosure.

In operation, the system 202 may be configured to receive the first input including the set of economic activities in the geographical region. The system 202 may be further configured to retrieve the first emission data associated with the second set of economic sectors. The first set of economic sectors may be associated with the second set of economic sectors in the geographical region. The first emission data indicates the emission of the set of pollutants by each economic sector of the second set of economic sectors. In other words, the first emission data may correspond to the contribution of each economic sector to the emission of the set of pollutants. In an embodiment, the first emission data may correspond to a first emission table. The first emission table may include emissions of the set of pollutants from various geographical regions (e.g., one or more countries) across the second set of economic sectors. The emissions of the set of pollutants may be represented as values under each economic sector of the second set of economic sectors for various geographical regions. In an embodiment, the system 202 may receive the first input from the server 210. Further, the system 202 may retrieve the first emission data from the one or more databases 208.

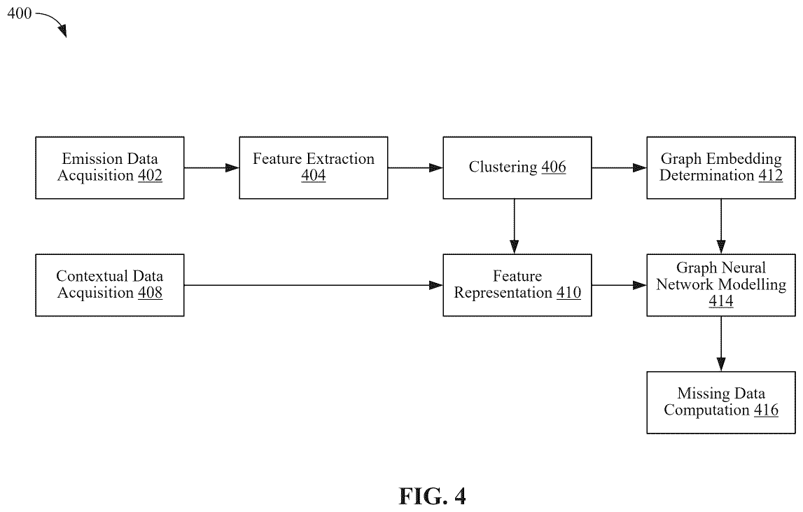

Upon receiving the first input and retrieving the first emission data, the system 202 may be configured to provide the first input and the first emission data, as an input, to the first ML model 206A. The first ML model 206A may be pre-trained on the training dataset that may include one or more economic sectors associated with the second set of economic sectors. In an embodiment, the first emission table of the first emission data may have one or more emission values indicative of the emission by the organization in the corresponding economic sector. The one or more missing values may correspond to unavailable emission values for any specific geographic region, time period, or sector. The system 202 may be configured to apply the first ML model 206A of the set of ML models 206 on the first emission data to identify the one or more missing values in the first emission table. In an embodiment, the system 202 may be configured to apply the first ML model 206A on the first emission data to determine a set of clusters based on the identification of the one or more missing values. Each cluster of the set of clusters may be associated with at least one of the geographical region, a time period, and a subset of economic sectors of the second set of economic sectors. In an embodiment, the emission value associated with the first emission data for each cluster of the set of clusters associated with at least one of the geographical region, the time period, and the subset of economic sectors may be identical. Details about the generation of the set of clusters are provided, for example, in FIG. 4.

The system 202 may be configured to apply the first ML model 206A on the set of clusters to generate a set of graph data structures. The set of graph data structures may refer to a graph structure where a set of nodes (e.g., data points) are grouped into clusters based on similarity in the emission value within the first emission data. In an embodiment, the set of nodes in the clusters may represent different entities such as at least one of the geographical regions, the time period, or the subset of economic sectors. Additionally, the set of nodes may be coupled with each other by edges that may represent relationships or similarities in the first emission table.

The system 202 may be further configured to apply the first ML model 206A on the set of graph data structures to generate a graph embedding vector for each graph data structure of the set of graph data structures. The graph embedding vector may correspond to a numeric representation of each graph data structure of the set of graph data structures such that complex structures and relationships between the set of nodes are captured into a low-dimensional vector space. Alternatively, the graph embedding vector may correspond to a numeric representation of an individual node within each cluster of the set of clusters. Upon generating the graph embedding vector for each graph data structure of the set of graph data structures, the system 202 may be further configured to retrieve the contextual data associated with the second set of economic sectors in the geographical region. The contextual data may be retrieved from the one or more databases 208. In an embodiment, the system 202 may be further configured to apply the first ML model 206A on the retrieved contextual data and the determined set of clusters to determine a feature representation for each graph data structure of the set of graph data structures. In various embodiments of the disclosure, the system 202 may be further configured to apply the first ML model 206A on the retrieved contextual data and the graph embedding vector for each graph data structure of the set of graph data structures to determine a feature representation for each graph data structure of the set of graph data structures based.

In an embodiment, the system 202 may include a graph-based foundation model that may correspond to a pre-trained model. The graph-based foundation model may utilize the graph data structure (e.g., the set of graph data structures) to process the emission data. The graph-based foundation model may capture relationships and dependencies that may exist in a graph data structure of the set of graph data structures. In other words, the graph-based foundation model may capture relationships and dependencies that may exist in the first emission data. The system 202 may be further configured to tune the graph-based foundation model based on the determined feature representation for each graph data structure and the generated graph embedding vector for each graph data structure. Based on tuning, the graph-based foundation model may adjust or refine model parameters, thereby improving predictions or analysis associated with the graph-based foundation model. The graph-based foundation model may analyze at least one of a spatial relationship, a temporal relationship, and a sectoral relationship of the set of pollutants by each economic sector of the second set of economic sectors.

In an embodiment, the spatial relationship of the set of pollutants by each economic sector of the second set of economic sectors may correspond to the geographic distribution of emission of the set of pollutants by different economic sectors. Further, the temporal relationship of the set of pollutants by each economic sector of the second set of economic sectors may correspond to changes in the emission of the set of pollutants over time (e.g., season, year, or economic cycles). Additionally, the sectoral relationship of the set of pollutants by each economic sector of the second set of economic sectors may correspond to the contribution of different economic sectors in the emission of the set of pollutants and the interconnection between the different economic sectors.

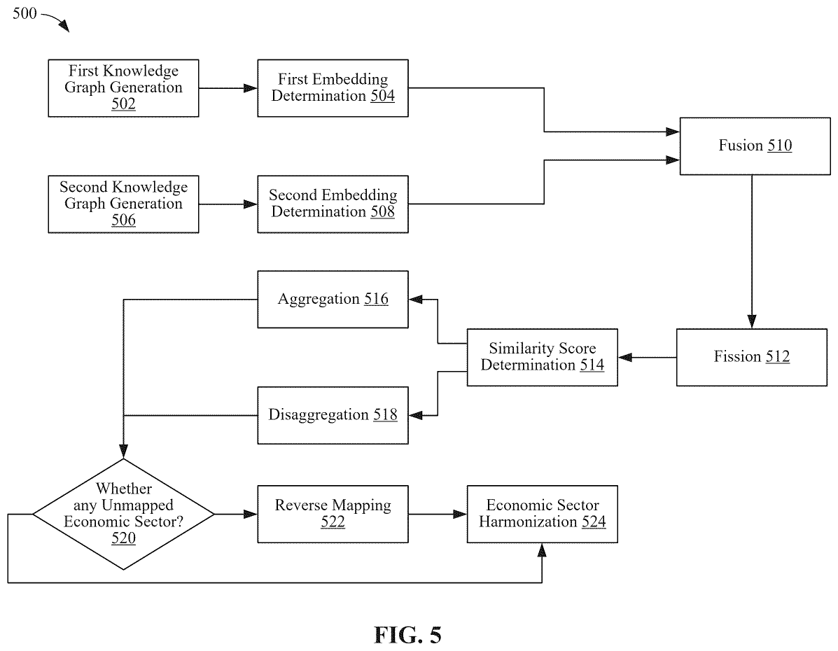

The system 202 may be further configured to determine the one or more missing values in the first emission table based on the tuned graph-based foundation model. Details about the determination of the one or more missing values are provided, for example, in FIG. 4. Further, upon determining the one or more missing values in the first emission table, the system 202 may be further configured to apply the second ML model 206B on the first input (e.g., the first set of economic sectors) to generate a first set of knowledge graphs. Additionally, the system 202 may be further configured to apply the second ML model 206B on the first emission data (e.g., the second set of economic sectors) to generate a second set of knowledge graphs. Details about the generation of the first set of knowledge graphs and the second set of knowledge graphs are provided, for example, in FIG. 5.

The system 202 may be further configured to apply the first ML model 206A on the first set of knowledge graphs and the second set of knowledge graphs to generate a first set of embedding vectors and a second set of embedding vectors, respectively. Furthermore, the system 202 may be further configured to apply the first ML model 206A on the first set of embedding vectors and the second set of embedding vectors to generate a third set of embedding vectors based on the aggregation of the first set of embedding vectors and the second set of embedding vectors. In an embodiment, the aggregation may correspond to combining the first set of embedding vectors and the second set of embedding vectors to generate a single set of representative vectors (e.g., the third set of embedding vectors). For example, the aggregation may be based on one of a sum aggregation, a mean aggregation, a max/min aggregation, or the like.

The system 202 may be further configured to apply the first ML model 206A on the third set of embedding vectors to generate a fourth set of embedding vectors based on the disaggregation of the third set of embedding vectors. For example, the disaggregation may be based on predefined criteria or learned patterns such as segmenting vectors based on specific attributes, dimensionality reduction techniques, or the like. Further, system 202 may be configured to apply the first ML model 206A on the generated fourth set of embedding vectors to harmonize the first set of economic sectors with the second set of economic sectors. Based on the harmonization of the first set of economic sectors with the second set of economic sectors, each economic sector of the first set of economic sectors may be associated with at least one economic sector of the second set of economic sectors. Details about the harmonization of the first set of economic sectors with the second set of economic sectors are provided, for example, in FIG. 5.

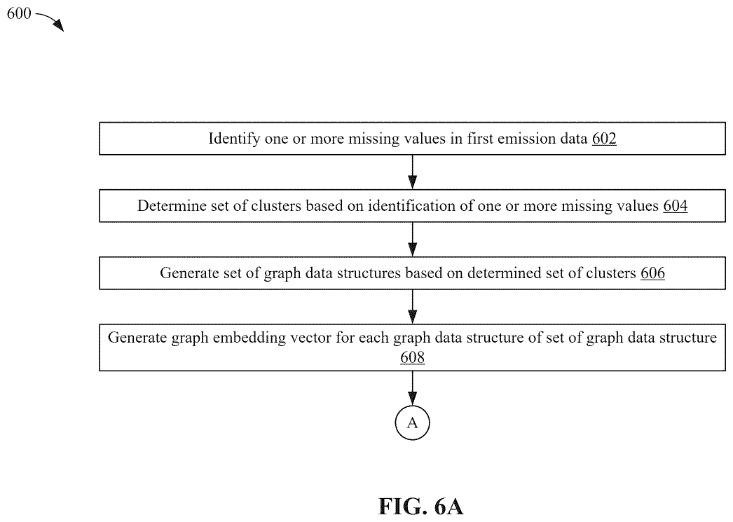

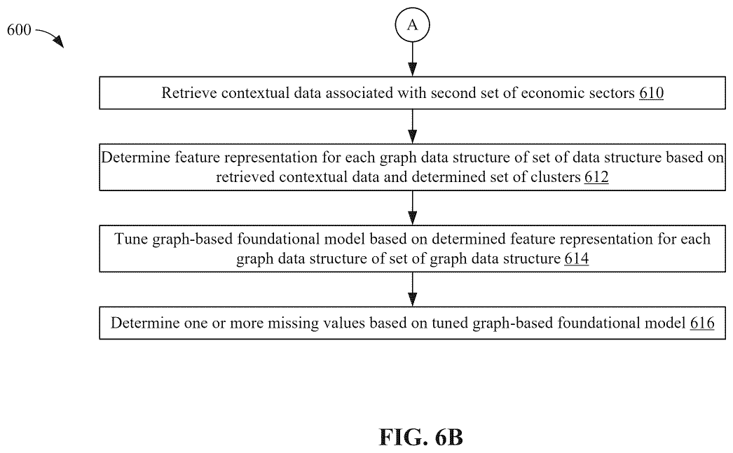

In an embodiment, the system 202 may be further configured to determine that a first economic sector of the first set of economic sectors is unharmonized with at least one economic sector of the second set of economic sectors. Further, the system 202 may be configured to apply the first ML model 206A on the first economic sector and the second set of economic sectors to execute a reverse mapping of the first economic sector with the at least one economic sector of the second set of economic sectors. The reverse mapping is executed based on the determination that the first economic sector is unharmonized with the at least one economic sector of the second set of economic sectors. The system 202 may be further configured to apply the first ML model 206A on the first economic sector and the second set of economic sectors to harmonize the first economic sector with the at least one economic sector of the second set of economic sectors based on the reverse mapping. Additionally, the system 202 may be further configured to apply the first ML model 206A on the harmonized first set of economic sectors (including the first economic sector) to generate second emission data. The system 202 may be further configured to receive second emission data that may be indicative of harmonized emission data of the second set of economic sectors, as an output, of the first ML model 206A. Further, the system 202 may be configured to render the generated second emission data. Details about the generated second emission data are provided, for example, in FIG. 6.

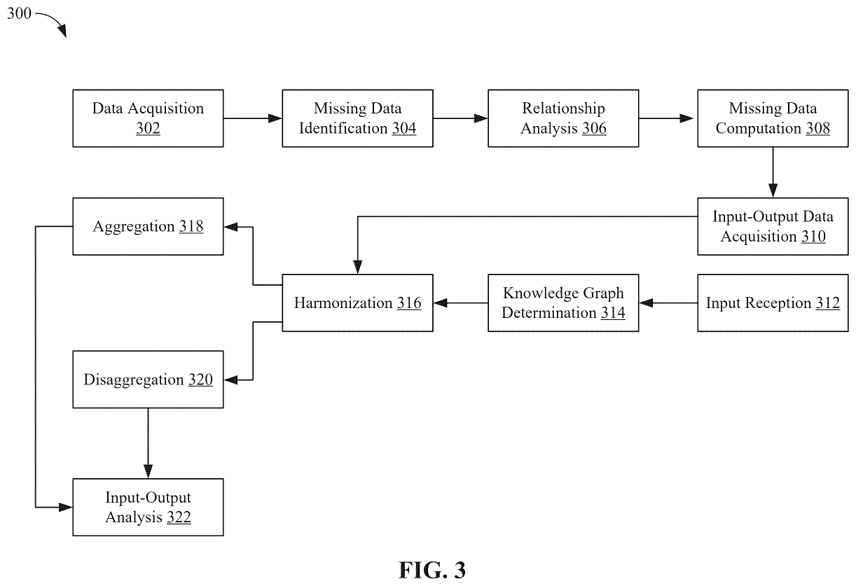

FIG. 3 is a diagram that illustrates exemplary operations for determining one or more missing values in the emission data and calculating the emission data based on the harmonization of the economic sectors, in accordance with an embodiment of the disclosure. FIG. 3 is explained in conjunction with elements from FIG. 1, and FIG. 2. With reference to FIG. 3, there is shown a block diagram 300 that illustrates exemplary operations from 302 to 324, as described herein. The exemplary operations illustrated in the block diagram 300 may start at 302 and may be performed by any computing system, apparatus, or device, such as by the computer 102 of FIG. 1 or system 202 of FIG. 2. Although illustrated with discrete blocks, the exemplary operations associated with one or more blocks of the block diagram 300 may be divided into additional blocks, combined into fewer blocks, or eliminated, depending on the particular implementation.

At 302, a data acquisition operation may be executed. In the data acquisition operation, the system 202 may be configured to retrieve the first emission data associated with the second set of economic sectors. The first emission data may include the emission of the set of pollutants (e.g., CO₂, CH₄, N₂O, O₃, or the like) by at least one of factories, industries, organizations, or the like associated with each economic sector of the second set of economic sectors. The first emission data may be retrieved from the one or more databases 208. In an embodiment, the first emission data may correspond to the first emission table that may include the emission values associated with the second set of economic sectors (e.g., agriculture, mining, fishing, textile, or the like) within a plurality of geographical regions (say one or more countries) for. In an embodiment, the system 202 may be configured to utilize web crawling techniques and application programming interfaces (APIs) calls to continuously scan the one or more databases 208 to retrieve the up-to-date first emission data associated with the second set of economic sectors.

In an alternate embodiment, the first emission data may correspond to at least one of the infographic representations, emission heatmaps, emission timeline charts, or the like associated with the emission of the set of pollutants by the at least one of the factories, industries, organizations, or the like associated with each economic sector. In such an embodiment, the system 202 may retrieve the first emission data from one or more servers associated with at least one of government agency, international organizations, research institutions, or the like. The system 202 may be further configured to provide the first emission data, as an input, to the first ML model 206A.

In an exemplary embodiment, a portion of the first emission data is shown in Table 1 below:

TABLE 1
First Emission Data

| Countries | Agriculture | Fishing | Mining | Rubber |
|---|---|---|---|---|
| Australia | 10.922 | 1.278 | 1.025 | 0.694 |
| Austria | 1.207 | 0.004 | 0.009 | 0.062 |
| Belgium | 2.064 | 0.034 | 0.001 | 0.332 |
| Canada | 24.3 | 0.291 | 3.234 | 5.736 |
| Chile | 1.542 | 0.873 | 0.037 | 2.074 |

With reference to Table 1, it may be noted that Australia emits 10.922 tons of a pollutant (say NO₂) per $1000 revenue in the agriculture sector, 1.278 tons of NO₂ per $1000 revenue in the fishing sector, 1.025 tons of NO₂ per $1000 revenue in the mining sector, and 0.694 tons of NO₂ per $1000 revenue in the rubber sector. Similarly, Austria emits 1.207 tons of NO₂ per $1000 revenue in the agriculture sector, 0.004 tons of NO₂ per $1000 revenue in the fishing sector, 0.009 tons of NO₂ per $1000 revenue in the mining sector, and 0.062 tons of NO₂ per $1000 revenue in the rubber sector.

Further, in the data acquisition operation, the system 202 may be configured to retrieve the contextual data associated with the second set of economic sectors in the geographical region. The contextual data may include at least one of economic indicator information of the geographical region, demographic indicator information of the geographical region, social indicator information of the geographical region, or the like. In an embodiment, the system 202 may be further configured to apply the first ML model 206A on the one or more databases 208 to utilize web crawling techniques and APIs to continuously scan the one or more databases 208 to retrieve the contextual data associated with the second set of economic sectors within the geographic region. Details about the contextual data are provided, for example, in FIG. 4.

At 304, a missing data identification operation may be executed. In the missing data identification operation, the system 202 may be further configured to apply the first ML model 206A on the first emission table of the first emission data to identify one or more missing values in the first emission table of the first emission data. In an embodiment, the one or more missing values may correspond to unavailable emission values for any specific geographic region, time period, or sector. In an embodiment, the system 202 may be further configured to apply the first ML model 206A on the first emission table to identify one or more incorrect values in the first emission table. The one or more incorrect values may be identified based on anomaly detection, range and threshold verification, time-series analysis, or the like. Further, the one or more incorrect values may be assumed as the one or more missing values.

At 306, a relationship analysis operation may be executed. In the relationship analysis operation, the system 202 may be further configured to tune the graph-based foundation model based on the first emission data and the contextual data associated with the second set of economic sectors upon identifying the one or more missing values in the first emission table of the first emission data. The graph-based foundation model may analyze at least one of the spatial relationship, the temporal relationship, and the sectoral relationship of the set of pollutants by each economic sector of the second set of economic sectors. Details about relationship analysis are provided, for example, in FIG. 4.

At 308, a missing data computation operation may be executed. In the missing data computation operation, the system 202 may be further configured to apply the first ML model 206A on the first emission table to determine or compute the identified one or more missing values in the first emission table based on the tuned graph-based foundation model. Details about determination of the one or more missing values are provided, for example, in FIG. 4.

At 310, an input-output data acquisition operation may be executed. In the input-output data acquisition operation, the system 202 may be further configured to receive input-output data associated with the second set of economic sectors based on the determination or computation of the one or more missing values. In an embodiment, the one or more databases 208 may be further configured to store the input-output data associated with the second set of economic sectors. Further, the system 202 may receive the input-output data from the one or more databases 208. The input-output data may include data associated with the flow of goods, services, and resources between different sectors of the second set of economic sectors. In an embodiment, input data of the input-output data may include resources such as raw materials, capital, imported goods, labor, or the like that may be consumed by one or more economic sectors of the second set of economic sectors. Further, output data of the input-output data may include products and services generated by one or more economic sectors of the second set of economic sectors using the resources. The input-output data may be used to analyze economic interdependencies, determine the contribution of each economic sector of the second set of economic sectors to gross domestic product (GDP), evaluate overall efficiency, or the like.

In an exemplary embodiment, a portion of the input-output data is shown in Table 2 below:

TABLE 2
Input-Output Data

| | AUS_01T02 | AUS_03 | AUS_05T06 | AUS_07T08 |
|---|---|---|---|---|
| AUS_01T02 | 9643.15001 | 1086.29584 | 52.580112 | 136.352413 |
| AUS_03 | 527.834592 | 134.506115 | 14.185165 | 13.601429 |
| AUS_05T06 | 169.967489 | 10.944585 | 2412.0047 | 1782.33666 |
| AUS_07T08 | 101.615163 | 11.825257 | 338.164605 | 6820.27797 |

Table 2 depicts the interdependencies of various sectors in Australia on each other. The values associated with the table 2 may represent monetary flows, indicating a value of output from one economic sector is used as input to another economic sector. For example, a value of 9643.15001 in row AUS_01T02 and column AUS_01T02 may represent that $9643 million worth of agricultural output is used as input for the agriculture sector. Similarly, a value of 1086.29584 in row AUS_01T02 and column AUS_03 may represent that $1086 million worth of the agricultural output is used as input for the fishing sector (AUS_03).

At 312, an input reception operation may be executed. In the input reception operation, the system 202 may be further configured to receive the first input including the first set of economic sectors in the geographical region. The first set of economic sectors may correspond to a predefined set of sectors that may be standardized to streamline the classification of various economic sectors. In an embodiment, the system 202 may receive the first input from the server 210. The server 210 may receive the first input from the user device (not shown) associated with the user (not shown). Further, the system 202 may provide the first input, as an input, to the first ML model 206A.

At 314, a knowledge graph determination operation may be executed. In the knowledge graph determination operation, the system 202 may be further configured to apply the second ML model 206B on the first input and the first emission data to generate the first set of knowledge graphs and the second set of knowledge graphs respectively. In an embodiment, the first set of knowledge graphs may be generated based on the first input and the second set of knowledge graphs may be generated based on the first emission data. Details about the generation of the first set of knowledge graphs and the second set of knowledge graphs are provided, for example, in FIG. 5.

At 316, a harmonization operation may be executed. In the harmonization operation, the system 202 may be further configured to apply the first ML model 206A on the first set of knowledge graphs and the second set of knowledge graphs to harmonize the first set of economic sectors with the second set of economic sectors. Additionally, the system 202 may be further configured to apply the first ML model 206A on the input-output data associated with the second set of economic sectors to harmonize the first set of economic sectors with the second set of economic sectors. In an embodiment, a mapping may exist between the first set of economic sectors and the second set of economic sectors. The mapping may be determined based on one of aggregation or disaggregation as discussed in further steps, for example, in FIG. 5.

At 318, an aggregation operation may be executed. In the aggregation operation, the system 202 may be further configured to apply the first ML model 206A on the first emission data to aggregate the first emission data associated with the second set of economic sectors such that the aggregated first emission data may be associated with a first set of economic sectors. In an embodiment, the system 202 may use the input-output data to aggregate the first emission data. In an exemplary embodiment, the first emission data is associated with 100 economic sectors. Further, the aggregated first emission data may be associated with only 66 economic sectors. The 66 economic sectors may correspond to an aggregated version of the 100 economic sectors. For example, the economic sectors such as hunting, fishing, and forestry may correspond to a single economic sector of the second set of economic sectors (e.g., 100 economic sectors). Further, the first emission data associated with hunting, fishing, and forestry may be aggregated such that the aggregated first emission data may be associated with hunting, fishing, and forestry as a combined single economic sector of the first set of economic sectors.

At 320, a disaggregation operation may be executed. In the disaggregation operation, the system 202 may be further configured to apply the first ML model 206A on the first emission data to disaggregate the first emission data associated with the second set of economic sectors such that the disaggregated first emission data may be associated with the first set of economic sectors. In an exemplary embodiment, the first emission data is associated with 50 economic sectors. Further, the disaggregated first emission data may be associated with 66 economic sectors. The 66 economic sectors may correspond to a disaggregated version of the 50 economic sectors. For example, fishing may correspond to an individual economic sector of the first set of economic sectors (e.g., 50 economic sectors). Further, the first emission data associated with fishing may be disaggregated such that the disaggregated first emission data may be associated with commercial fishing and inland fishing as different economic sectors of the first set of economic sectors. In an embodiment, one of the aggregation operation or the disaggregation operation may be executed for a pair of the first set of economic sectors and the second set of economic sectors (e.g., 50 economic sectors and 66 economic sectors, or 100 economic sectors and 66 economic sectors).

At 322, an input-output analysis operation may be executed. In the input-output analysis operation, the system 202 may be configured to generate second emission data based on the harmonization of the first set of economic sectors with the second set of economic sectors. In other words, the system 202 may be configured to generate the second emission data based on the aggregated first emission data that may be associated with the first set of economic sectors. Alternatively, the system 202 may be configured to generate the second emission data based on the disaggregated first emission data that may be associated with the first set of economic sectors. In an embodiment, the second emission data may be generated based on Leontief analysis. The Leontief analysis may be used to determine interdependencies between different economic sectors of the second set of economic sectors. The system 202 may use the Leontief analysis on the first set of economic sectors that are harmonized. The system 202 may further use the input-output table to generate the second emission data. The second emission data may be indicative of harmonized emission data (e.g., harmonized first emission data) associated with the second set of economic sectors. In an embodiment, the generated second emission data may bring uniformity to the spend-based emission factors for scope 3 computation.

In an exemplary embodiment, a portion of the second emission data is shown in Table 2 below:

TABLE 3
Second Emission Data

| | Agriculture, Hunting, | Fishing and |
|---|---|---|
| Countries | and Forestry | Aquaculture |
| Australia | 0.386966 | 0.412305 |
| Austria | 0.215521 | 0.171621 |
| Belgium | 0.366160 | 0.343758 |
| Canada | 0.6182766 | 0.233842 |
| Chile | 0.254036 | 0.361179 |

The system 202 may use the Table 1 and Table 2 to generate Table 3 (e.g., the second emission data). Table 3 may depict that Australia may emit 0.386966 tons of NO₂ per dollars 1000 revenue in agriculture, hunting, and forestry as a combined economic sector, and 0.412305 tons of NO₂ per 1000 dollars revenue in fishing and aquaculture as another combined economic sector.

In various embodiments of the disclosure, system 202 may use the table 1 to determine emission data for each economic sector of the second set of economic sectors. Further, the system 202 may use the table 2 to determine revenue generated by each economic sector of the second set of economic sectors. Based on the revenue generated by each economic sector of the second set of economic sectors, the system 202 may determine weights associated with each economic sector of the second set of economic sectors. Additionally, the system 202 may determine spend-based emission factors for scope 3 computation for an economic sector that may correspond to a combination of one or more economic sectors of the second set of economic sectors. For example, the system 202 may determine that revenue associated with economic sectors such as hunting, forestry, and fishing may be $10 million, $50 million, and $100 million, respectively. Further, the system 202 may determine that emission data associated with the economic sectors such as hunting, forestry, and fishing may be 0.001 tons per dollar, 0.002 tons per dollar, and 0.003 tons per dollar, respectively. The system 202 may further determine weights associated with the economic sectors such as hunting, forestry, and fishing by dividing individual revenue by total revenue. Thus, weights associated with hunting may be 10/(10+50+100)=0.0625, weights associated with forestry may be 50/(10+50+100)=0.3125, and weights associated with fishing may be 10/(10+50+100)=0.625. Furthermore, the system 202 may determine spend-based emission factors for scope 3 computation for an economic sector that may correspond to a combination of hunting, forestry, and fishing as (0.0625*0.001)+(0.3125*0.002)+(0.625*0.003)=0.00256 tons per dollar.

In various embodiments of the disclosure, the system 202 may combine a financial model and an emission model to determine spend-based emission factors for scope 3 computation. The financial model may utilize the input-output table that incorporates intermediate demand (Z^{D}), gross fixed capital formation (K^{D}), and sectoral outputs (y). The intermediate demand (Z^{D}) may correspond to the demand for goods and services that are used as inputs in the production of other goods and services. The gross fixed capital formation (K^{D}) may correspond to the net increase in physical assets (like machinery, buildings, and infrastructure) within the geographical region over a certain period. The sectoral outputs (y) may correspond to the total production output of each economic sector in the second set of economic sectors.

The emission model may apply direct emission values (eₚₚ) for each economic sector to calculate total emission (Eₚₚ) based on domestic output (xₚₚ). Further, a technical coefficients matrix, represented by [A^{D}+B^{D}], reflects inter-industry relationships, allowing computation of total sectoral output through the Leontief inverse matrix given by (1−(A^{D}+B^{D}))⁻¹*eₚₚ. The Leontief inverse matrix may account for how changes in final demand influence overall production in the economy. Details about the Leontief inverse matrix are known in the art and have been omitted for the sake of brevity.

Upon linking sectoral output to the corresponding emission factor, the system 202 may generate a detailed view of sectoral (e.g., economic sectoral) contribution to total emissions. In various embodiments of the disclosure, the system 202 may incorporate a consumer price index (CPI) adjustment to account for inflation over time, thereby ensuring that a total emission vector (e^{total}) may be standardized in terms of real economic output. In an embodiment, a unit associated with the total emission vector (e^{total}) may be given by kg CO₂e/£PP, the unit may correspond to CO₂ emissions in kilograms for each unit of financial output (e.g., per pound). Further, the result may be the total emission vector adjusted for inflation, represented in units such as kg CO₂e/£PP.

FIG. 4 is a diagram that illustrates exemplary operations for determining one or more missing values in the emission data, in accordance with an embodiment of the disclosure. FIG. 4 is explained in conjunction with elements from FIG. 1, FIG. 2, and FIG. 3. With reference to FIG. 4, there is shown a block diagram 400 that illustrates exemplary operations from 402 to 416, as described herein. The exemplary operations illustrated in the block diagram 400 may start at 402 and may be performed by any computing system, apparatus, or device, such as by the computer 102 of FIG. 1 or system 202 of FIG. 2. Although illustrated with discrete blocks, the exemplary operations associated with one or more blocks of the block diagram 400 may be divided into additional blocks, combined into fewer blocks, or eliminated, depending on the particular implementation.

At 402, an emission data acquisition operation may be executed. In the emission data acquisition operation, the system 202 may be configured to retrieve the first emission data associated with the second set of economic sectors. The system 202 may retrieve the first emission data from the one or more databases 208. In an embodiment, the one or more databases 208 may be configured to receive the first emission data from various international emission databases. After retrieving the first emission data, the system 202 may be further configured to provide the first emission data, as an input, to the first ML model 206A. Details about the emission data are provided, for example, at 302 in FIG. 3.

At 404, a feature extraction operation may be executed. In the feature extraction operation, the system 202 may be further configured to apply the first ML model 206A on the first emission table of the first emission data to identify one or more missing values in the first emission table. In an embodiment, the system 202 may use various techniques to identify the one or more missing values, such as using logical functions (e.g., isna( ) in Python) to generate boolean masks that indicate where data is missing or not. Additionally, the system 202 may use summary statistics of the first emission table and visualizations of the first emission table to identify the one or more missing values. In additional embodiments, the first ML model 206A may be trained to recognize patterns indicative of missing data (e.g., one or more missing values), thereby allowing the system 202 to identify the missing data (e.g., one or more missing values). The system 202 may be further configured to apply the first ML model 206A on the first emission table to extract a set of features from the first emission table based on the identification of the one or more missing values. The set of features may include at least one of spatial features, temporal features, sectoral features associated with each economic sector of the second set of economic sectors, or the like.

In an embodiment, the extraction of the spatial features may correspond to analyzing the geographical distribution of emissions across different regions such as continents, countries, cities, or the like. The extraction of the temporal features may correspond to analyzing changes in emission levels over time, capturing trends, seasonal variations, periodic fluctuations, or the like. The analysis of the temporal features may be used to detect long-term trends or short-term anomalies in the emission data (e.g., the first emission data). Additionally, the extraction of the sectoral features may correspond to analyzing emissions with one or more economic sectors such as energy production, transportation, agriculture, or the like.

At 406, a clustering operation may be executed. In the clustering operation, the system 202 may be further configured to apply the first ML model 206A on the first emission table to determine the set of clusters based on the extraction of the set of features. Each cluster of the determined set of clusters may be associated with at least one of the geographical region, a time period, or a subset of economic sectors of the second set of economic sectors. In an embodiment, the system 202 may determine the set of clusters based on identical emission data in the first emission data. For example, a first cluster of the set of clusters may include the United States of America (USA), Germany, and France, where the emission pattern is identical due to comparable industrial activities and energy consumption profiles. Further, a second cluster of the set of clusters may include a time period from the year 2010 to the year 2020, during which the first emission data shows similar trends across multiple years that may reflect significant emission policy changes or technological advancements in various areas such as efficient machinery, improved fuel standards, enhanced carbon capture methodologies, or the like. Additionally, a third cluster of the set of clusters may be associated with the subset of economic sectors such as the energy sector, where emissions from oil refineries, power plants, and natural gas facilities may exhibit similar characteristics.

Furthermore, a fourth cluster of the set of clusters may be associated with a combination of at least one of the geographical region, the time period, or the subset of economic sectors. For example, the fourth cluster may be associated with emissions in the automobile sector across North America during a time period from year 2010 to year 2015.

The set of graph data structures may refer to a graph structure where nodes (e.g., data points) are grouped into clusters based on similarity. In the graph data structure, various nodes may be coupled with each other by edges that may represent relationships or similarities between the nodes. The system 202 may be further configured to apply the first ML model 206A on the determined set of clusters to generate the set of graph data structures. For example, when the first cluster of the set of clusters may include the USA, Germany, and France, where emission patterns are identical due to comparable industrial activities and energy consumption profiles, a first graph data structure of the set of graph data structures may be generated based on the first cluster such that the nodes of the first graph data structure may correspond to USA, Germany, and France. Further, edges between different nodes of the first graph data structure may correspond to the identical emission pattern.

At 408, a contextual data acquisition operation may be executed. In the contextual data acquisition operation, the system 202 may be configured to retrieve the contextual data associated with the second set of economic sectors in the geographical region. The contextual data may include at least one of the economic indicator information of the geographical region, the demographic indicator information of the geographical region, the social indicator information of the geographical region, or the like. For example, the system 202 may retrieve the unemployment rate in a particular geographical region up from 20% to 30% indicating economic distress in the particular geographical region. In an embodiment, the system 202 may be configured to utilize web crawling techniques and APIs to continuously scan the one or more databases 208 to retrieve the contextual data associated with the second set of economic sectors.

At 410, a feature representation operation may be executed. In the feature representation operation, the system 202 may be further configured to apply the first ML model 206A on the retrieved contextual data and the determined set of clusters to determine a feature representation for each graph data structure of the set of graph data structures. In an embodiment, the system 202 may analyze relationships and interactions between each cluster of the determined set of clusters based on the retrieved contextual data. By analyzing the relationships and the interactions, the system 202 may determine the feature representation for each graph data structure of the set of graph data structures.

At 412, a graph embedding determination operation may be executed. In the graph embedding determination operation, the system 202 may be further configured to apply the first ML model 206A on the set of graph data structures to generate a graph embedding vector for each graph data structure of the set of graph data structures. A graph embedding may refer to a technique to represent nodes and edges of a graph data structure as continuous vectors in a low-dimensional space. Further, the graph embedding vector may correspond to a numeric representation of each graph data structure of the set of graph data structures such that complex structures and relationships between various nodes are captured into a low-dimensional vector space. In an embodiment, the first ML model 206A may correspond to a graph convolution network (GCN). The GCN may extend traditional CNN to work on graphs (e.g., the set of graph data structures). The GCN may generate the graph embedding vector for each graph data structure of the set of graph data structures by iteratively aggregating and combining features from a neighbor node through a layer-wise propagation process.

At 414, a graph neural network modeling operation may be executed. In the graph neural network modeling operation, the system 202 may be configured to tune the graph-based foundation model based on the determined feature representation for each graph data structure and the generated graph embedding vector for each graph data structure. Based on tuning, the graph-based foundation model may adjust or refine model parameters, thereby improving predictions or analysis associated with the graph-based foundation model.

The system 202 may be further configured to initiate graph neural network modeling to update the graph embedding vector for each graph data structure of the set of graph data structures. In an embodiment, the graph embedding vector for each graph data structure of the set of graph data structures may be updated based on the feature representation for each graph data structure of the set of graph data structures. For example, when the feature representation for a graph data structure of the set of graph data structures indicates economic slowdown, the graph embedding vector for the corresponding graph data structure is updated to reflect these changes, thereby allowing the system 202 to predict a corresponding decrease in emissions due to lower production levels, and thus identify one or more missing values in the first emission table.

In an embodiment, the graph-based foundation model may further analyze at least one of the spatial relationship, the temporal relationship, and the sectoral relationship of the set of pollutants by each economic sector of the second set of economic sectors. Based on the analysis, the graph-based foundation model may further update the graph embedding vector for each graph data structure of the set of graph data structures, thereby allowing the system 202 to identify one or more missing values in the first emission table.

At 416, a missing data computation operation may be executed. In the missing data computation, the system 202 may be configured to determine the one or more missing values in the first emission table. Based on the determination of the one or more missing values in the first emission table, the system 202 may be further configured to tune the first ML model 206A based on the updated graph embedding vector for each graph data structure of the set of graph data structure. Based on the updated graph embedding vector for each graph data structure of the set of graph data structures, the first ML model 206A may leverage the contextual data to identify patterns and relationships, thereby identifying the one or more missing values accurately. For example, when the first emissions data may include the one or more missing values, the first ML model 206A may infer emission values from a first cluster of the set of clusters identical to a second cluster of the set of clusters based on similar sectors, spatial relationships, and temporal trends to identify the one or more missing values.

Although it is mentioned that the one or more missing values are determined based on the tuning of the graph-based foundation model, in various other embodiments, the one or more missing values are determined based on other neural network models. Details about the determination of the one or more missing values are known in art and therefore have been omitted for the sake of brevity.

FIG. 5 is a diagram that illustrates exemplary operations for calculating the emission data based on the harmonization of the economic sectors, in accordance with an embodiment of the disclosure. FIG. 5 is explained in conjunction with elements from FIG. 1, FIG. 2, FIG. 3, and FIG. 4. With reference to FIG. 5, there is shown a block diagram 500 that illustrates exemplary operations from 502 to 524, as described herein. The exemplary operations illustrated in the block diagram 500 may start at 502 and may be performed by any computing system, apparatus, or device, such as by the computer 102 of FIG. 1 or system 202 of FIG. 2. Although illustrated with discrete blocks, the exemplary operations associated with one or more blocks of the block diagram 500 may be divided into additional blocks, combined into fewer blocks, or eliminated, depending on the particular implementation.

At 502, a first knowledge graph generation operation may be executed. In the first knowledge graph generation operation, the system 202 may be further configured to receive the input from one or more databases 208. The first input received by the system 202 may correspond to a textual description associated with the first set of economic sectors. The system 202 may be configured to apply the second ML model 206B on the first input to determine the first set of economic sectors based on an application of one or more NLP techniques.

In an embodiment, the user device 204 may be configured to provide the first input that may correspond to the textual description associated with the first set of economic sectors such that the first input may be generated based on a predefined set of criteria defined by the user 212. In other embodiments, the user device 204 may be configured to provide the first input that may correspond to a tabular data such that the first input may be generated based on entries in the tabular data. Upon receiving the first input, the system 202 may be configured to apply the second ML model 206B on the first input to determine the first set of economic sectors. In an embodiment, the system 202 may extract relevant feature(s) based on an application of one or more NLP techniques on the first input. The system 202 may further map relationships between different economic sectors using the second ML model 206B to generate the first set of knowledge graphs, where nodes represent the first set of economic sectors and edges may represent relationships between the first set of economic sectors.

At 504, a first embedding determination operation may be executed. In the first embedding determination operation, the system 202 may be further configured to apply the first ML model 206A on the first set of knowledge graphs to generate the first set of embedding vectors. In an embodiment, the first ML model 206A may correspond to the GCN. The GCN may extend traditional CNN to work on graphs (e.g., knowledge graphs). The GCN may generate the first set of embedding vectors by iteratively aggregating and combining features from a neighbor node through a layer-wise propagation process.

At 506, a second knowledge graph generation operation may be executed. In the second knowledge graph generation operation, the system 202 may be further configured to apply the second ML model 206B on the first emission data (e.g., the second set of economic sectors) to generate the second set of knowledge graphs. The system 202 may receive the first emission data from the one or more databases 208. In an embodiment, the system 202 may extract relevant features based on an application of the one or more NLP techniques on the first emission data. The system 202 may further map relationships between different economic sectors using the second ML model 206B to generate the second set of knowledge graphs, where nodes represent the second set of economic sectors and edges may represent relationships (e.g., emission data) between the second set of economic sectors.

At 508, a second embedding determination operation may be executed. In the second embedding determination operation, the system 202 may be further configured to apply the first ML model 206A on the second set of knowledge graphs to generate the second set of embedding vectors. In an embodiment, the first ML model 206A may correspond to the GCN. The GCN may generate the second set of embedding vectors by iteratively aggregating and combining features from a neighboring node through a layer-wise propagation process.

At 510, a fusion operation may be executed. In the fusion operation, the system 202 may be further configured to apply the first ML model 206A on the first set of embedding vectors and the second set of embedding vectors to aggregate the first set of embedding vectors and the second set of embedding vectors. The system 202 may be further configured to apply the first ML model 206A on the first set of embedding vectors and the second set of embedding vectors to generate the third set of embedding vectors based on the aggregation of the first set of embedding vectors and the second set of embedding vectors. The third set of embedding vectors may correspond to a fusion of the first set of embedding vectors and the second set of embedding vectors which may include harmonizing data from different sectors by resolving discrepancies in data formats, definitions, and measurement units. For example, when the first set of embedding vectors may report CO₂ emissions in metric tons and the second set of embedding vectors may report CO₂ emissions in kilograms, the ML model may combine the first set of embedding vectors and the second set of embedding vectors to standardize the measurements. The resulting set of embedding vectors (e.g., the third set of embedding vectors) may provide a unified view of emissions data across all sectors. Additionally, a set of economic sectors associated with the third set of embedding vectors may indicate a reduced number from the first set of embedding vectors and the second set of embedding vectors. For example, when the first set of embedding vectors corresponds to 66 economic sectors and the second set of embedding vectors corresponds to 100 economic sectors, upon fusion, the third set of embedding vectors may correspond to 40 economic sectors.

In an embodiment, the system 202 may be further configured to apply the first ML model 206A on the first set of knowledge graphs and the second set of knowledge graphs to combine the first set of knowledge graphs and the second set of knowledge graphs to generate a third set of knowledge graphs. The third set of knowledge graphs may correspond to a fusion of the first set of knowledge graphs and the second set of knowledge graphs which may include harmonizing data from different sectors by resolving discrepancies in data formats, definitions, and measurement units.

At 512, a fission operation may be executed. In the fission operation, the system 202 may be further configured to apply the first ML model 206A on the third set of embedding vectors to disaggregate the third set of embedding vectors. The system 202 may be further configured to apply the first ML model 206A on the third set of embedding vectors to generate the fourth set of embedding vectors based on the disaggregation of the third set of embedding vectors. The third set of embedding vectors may correspond to a fission of the third set of embedding vectors that may include splitting one or more economic sectors associated with the third set of embedding vectors to generate additional economic sectors. For example, when the third set of embedding vectors corresponds to 40 economic sectors, upon fission, the fourth set of embedding vectors may correspond to 60 economic sectors such that the first set of economic sectors is harmonized with the second set of economic sectors.

In an embodiment, the system 202 may be further configured to apply the first ML model 206A on the third set of knowledge graphs to split the third set of knowledge graphs to generate a fourth set of knowledge graphs. The fourth set of knowledge graphs may correspond to a fission of the third set of knowledge graphs that may include splitting the economic sectors associated with the third set of knowledge graphs to harmonize the first set of knowledge graphs with the second set of knowledge graphs.

At 514, a similarity score determination operation may be executed. In the similarity score determination operation, the system 202 may be further configured to apply the first ML model 206A on the harmonized first set of economic sectors and the second set of economic sectors to compare the harmonized first set of economic sectors with the second set of economic sectors to compute a similarity score between the harmonized first set of economic sectors and the second set of economic sectors. In an embodiment, the similarity score may be calculated based on predefined metrics such as Euclidean distance, cosine similarity, Jaccard index, Pearson correlation coefficient, or the like. For example, when the harmonized first set of economic sectors may include manufacturing and technology and the second set of economic sectors may include energy and technology, the ML model may compute a moderate similarity score based on energy as the common economic sector.

At 516, an aggregation operation may be executed. In the aggregation operation, the system 202 may be further configured to apply the first ML model 206A on the first emission data to aggregate the first emission data associated with the second set of economic sectors such that the aggregated first emission data may be associated with the first set of economic sectors. In an embodiment, the system 202 may use the input-output data to aggregate the first emission data. In an exemplary embodiment, the first emission data is associated with 100 economic sectors. Further, the aggregated first emission data may be associated with only 66 economic sectors. The 66 economic sectors may correspond to an aggregated version of the 100 economic sectors. For example, hunting, fishing, and forestry may correspond to individual economic sectors of the second set of economic sectors (e.g., 100 economic sectors). Further, the first emission data associated with hunting, fishing, and forestry may be aggregated such that the aggregated first emission data may be associated with hunting, fishing, and forestry as a combined economic sector of the first set of economic sectors.

At 518, a disaggregation operation may be executed. In the disaggregation operation, the system 202 may be further configured to apply the first ML model 206A on the first emission data to disaggregate the first emission data associated with the second set of economic sectors such that the disaggregated first emission data may be associated with the first set of economic sectors. In an exemplary embodiment, the first emission data is associated with 50 economic sectors. Further, the aggregated first emission data may be associated with 66 economic sectors. The 66 economic sectors may correspond to a disaggregated version of the 50 economic sectors. For example, fishing may correspond to an individual economic sector of the first set of economic sectors (e.g., 50 economic sectors). Further, the first emission data associated with fishing may be disaggregated such that the disaggregated first emission data may be associated with commercial fishing and inland fishing as different economic sectors of the first set of economic sectors.

In an embodiment, one of the aggregation operation or the disaggregation operation may be executed for a pair of the first set of economic sectors and the second set of economic sectors (e.g., 50 economic sectors and 66 economic sectors, or 100 economic sectors and 66 economic sectors). Further, a mapping may be generated based on one of the aggregation operations or the disaggregation operation such that each economic sector of the first set of economic sectors may be associated (e.g., mapped) with one or more economic sectors of the second set of economic sectors.

At 520, it may be determined whether there is any unmapped economic sector. In an embodiment, the unmapped economic sector may correspond to one or more economic sectors associated with the first set of economic sectors that may be unmapped with one or more economic sectors associated with the second set of economic sectors. In other words, the system 202 may be further configured to determine whether the first economic sector of the first set of economic sectors is unharmonized with at least one economic sector of the second set of economic sectors. In case one or more economic sectors associated with the first set of economic sectors may be unmapped (or unharmonized) with one or more economic sectors associated with the second set of economic sectors, then the control may be transferred to 522. Other, the control may be transferred to 524.

At 522, a reverse mapping operation may be executed. In the reverse mapping operation, the system 202 may be further configured to apply the first ML model 206A on the first economic sector and the second set of economic sectors to execute the reverse mapping of the first economic sector with the at least one economic sector of the second set of economic sectors. The system 202 may be further configured to apply the first ML model 206A on the first economic sector and the second set of economic sectors to harmonize the first economic sector with the at least one economic sector of the second set of economic sectors based on the reverse mapping. In an embodiment, after the reverse mapping operation, the system 202 may be further configured to determine whether there may be any further one or more unharmonized (or unmapped) economic sectors. In case there may be one or more unharmonized economic sectors, the system 202 may reinitiate the reverse mapping operation.

At 524, an economic sector harmonization operation may be executed. In the economic sector harmonization operation, the system 202 may be further configured to retrieve input-output data associated with the second set of economic sectors. The input-output data may include data associated with the flow of goods, services, and resources between different sectors of the second set of economic sectors. The system 202 may be further configured to apply the first ML model 206A on the harmonized first set of economic sectors to generate the second emission data.

In an embodiment, the second emission data may be generated based on Leontief analysis. The Leontief analysis may be used to determine interdependencies between different economic sectors of the second set of economic sectors. The system 202 may use the Leontief analysis on the first set of economic sectors that are harmonized. The system 202 may further use the input-output table to generate the second emission data. The second emission data may be indicative of harmonized emission data (e.g., harmonized first emission data) associated with the second set of economic sectors. In an embodiment, the generated second emission data may bring uniformity to the spend-based emission factors for scope 3 computation.

FIGS. 6A and 6B are diagrams that collectively illustrate a flowchart of an exemplary method for computation of the missing emission data, in accordance with an embodiment of the disclosure. FIGS. 6A and 6B are explained in conjunction with elements from FIG. 1, FIG. 2, FIG. 3, FIG. 4, and FIG. 5. With reference to FIGS. 6A and 6B there is shown a flowchart 600. The operations of the exemplary method may be executed by any computing system, for example, by the computer 102 of FIG. 1 or the system 202 of FIG. 2. The operations of the flowchart 600 may start at 602.

Referring now to FIG. 6A, at 602, one or more missing values in the first emission data are identified. In an embodiment of the disclosure, the system 202 may be further configured to apply the first ML model 206A on the first emission table of the first emission data to identify the one or more missing values in the first emission table. In an embodiment, the first emission data including the first emission table. Further, the one or more missing values may correspond to unavailable values for any specific geographic region, time period, or sector. Details about the identification of the one or more missing values are provided, for example, in FIG. 3.

At 604, the set of clusters may be determined. In an embodiment of the disclosure, the system 202 may be further configured to apply the first ML model 206A on the first emission table to determine the set of clusters based on the identification of the one or more missing values. In an embodiment, each cluster of the determined set of clusters may associated with at least one of the geographical region, the time period, or a subset of economic sectors of the second set of economic sectors. Details about the determination of the set of clusters are provided, for example, in FIG. 2 and FIG. 4.

At 606, the set of graph data structures is generated. In an embodiment of the disclosure, the system 202 may be further configured to apply the first ML model 206A on the determined set of clusters to generate the set of graph data structures. The set of graph data structures may refer to a graph structure where nodes (e.g., data points) are grouped into clusters based on similarity. Details about the generation of the set of graph data structures are provided, for example, in FIG. 2 and FIG. 4.

At 608, the graph embedding vector for each graph data structure of the set of graph data structures is generated. In an embodiment of the disclosure, the system 202 may be further configured to apply the first ML model 206A on the set of graph data structures to generate the graph embedding vector for each graph data structure of the set of graph data structures. The graph embedding vector may correspond to a numeric representation of each graph data structure of the set of graph data structures such that complex structures and relationships between various nodes are captured into a low-dimensional vector space.

Referring now to FIG. 6B, at 610, the contextual data associated with the second set of economic sectors is retrieved. In an embodiment of the disclosure, the system 202 may be configured to retrieve the contextual data associated with the second set of economic sectors in the geographical region. In an embodiment, the contextual data may include at least one of the economic indicator information of the geographical region, the demographic indicator information of the geographical region, the social indicator information of the geographical region, or the like. Details about retrieval of the contextual data are provided, for example, in FIG. 2 and FIG. 4.

At 612, a feature representation for each graph data structure of the set of graph data structures is determined. In an embodiment of the disclosure, the system 202 may be further configured to apply the first ML model 206A on the retrieved contextual data and the determined set of clusters to determine the feature representation for each graph data structure of the set of graph data structures.

At 614, the graph-based foundation model may be tuned. In an embodiment of the disclosure, the system 202 may be configured to tune the graph-based foundation model based on the determined feature representation for each graph data structure of the set of graph data structures and the generated graph embedding vector for each graph data structure of the set of graph data structures. In an embodiment, the tuned graph-based foundation model may analyze at least one of the spatial relationship, the temporal relationship, or the sectoral relationship of the set of pollutants by each economic sector of the second set of economic sectors. Details about the graph-based foundation model are provided, for example, in FIG. 2 and FIG. 4.

At 616, the one or more missing values are determined. In an embodiment of the disclosure, the system 202 may be configured to determine the one or more missing values in the first emission table based on the tuned graph-based foundation model. Details about the determination of the one or more missing values are provided, for example, in FIG. 2 and FIG. 4.

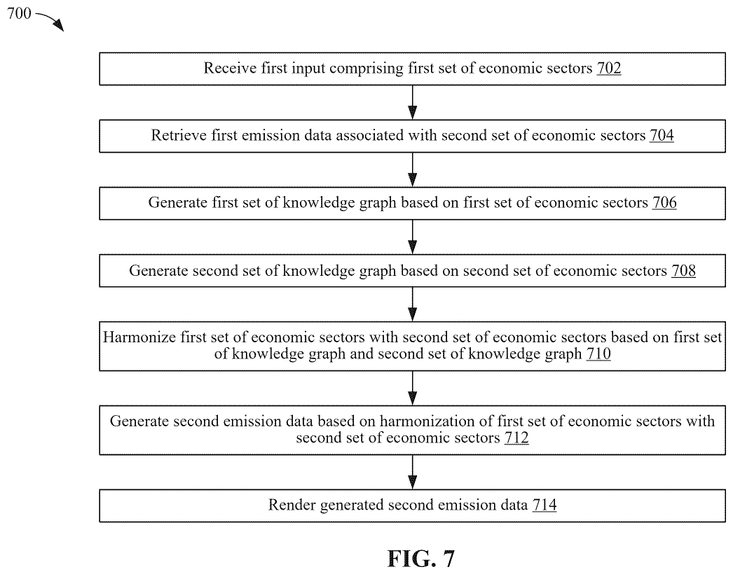

FIG. 7 is a diagram that illustrates a flowchart of an exemplary method for calculation of the emission data based on harmonization of the economic sectors, in accordance with an embodiment of the disclosure. FIG. 7 is explained in conjunction with elements from FIG. 1, FIG. 2, FIG. 3, FIG. 4, FIG. 5, FIG. 6A, and FIG. 6B. With reference to FIG. 7, there is shown a flowchart 700. The operations of the exemplary method may be executed by any computing system, for example, by the computer 102 of FIG. 1 or the system 202 of FIG. 2. The operations of the flowchart 700 may start at 702.

At 702, the first input including the first set of economic sectors in the geographical region is received. In an embodiment of the disclosure, the system 202 may be configured to receive the first set of economic sectors. Details about receiving the first set of economic sectors are provided, for example, in FIG. 2 and FIG. 3.

At 704, the first emission data associated with the second set of economic sectors may be retrieved. In an embodiment of the disclosure, the system 202 may be configured to retrieve the first emission data. Details about retrieving the first emission data are provided, for example, in FIG. 2 and FIG. 3. Upon receiving the first input and retrieving the first emission data, the system 202 may be configured to provide the first input and the first emission data, as an input, to the first ML model 206A.

At 706, the first set of knowledge graphs may be generated based on the first set of economic sectors. In an embodiment of the disclosure, the system 202 may be further configured to apply the first ML model 206A on the first input including the first set of economic sectors to generate the first set of knowledge graphs. Details about generating the first set of knowledge graphs are provided, for example, in FIG. 2 and FIG. 5.

At 708, the second set of knowledge graphs may be generated based on the second set of economic sectors. In an embodiment of the disclosure, the system 202 may be further configured to apply the first ML model 206A on the first emission data to generate the second set of knowledge graphs. Details about generating the second set of knowledge graphs are provided, for example, in FIG. 2 and FIG. 5.

At 710, the first set of economic sectors may be harmonized with the second set of economic sectors. In an embodiment of the disclosure, the system 202 may be further configured to apply the first ML model 206A on the first set of knowledge graphs and the second set of knowledge graphs to harmonize the first set of economic sectors with the second set of economic sectors. Details about harmonizing the first set of economic sectors with the second set of economic sectors are provided, for example, in FIG. 2 and FIG. 5.

At 712, the second emission data may be generated. In an embodiment of the disclosure, the system 202 may be further configured to apply the first ML model 206A on the harmonized first set of economic sectors to generate the second emission data. Details about the generation of the second emission data are provided, for example, in FIG. 2 and FIG. 5. The second emission data may be indicative of harmonized emission data of the second set of economic sectors.

At 714, the second emission data may be rendered. In an embodiment of the disclosure, the system 202 may be configured to render the second emission data. Examples of rendering of the received second emission data may correspond to converting the received second emission data into a visual representation on a display, processing the received second emission data to produce an audio output, transforming the received second emission data into a graphical interface, such as a chart or map, or the like. Control may pass to the end.

Various embodiments of the disclosure may provide a non-transitory computer readable medium and/or storage medium having stored thereon, instructions executable by a machine and/or a computer to operate a system (e.g., the system 202) for harmonization of economic sectors. The instructions may cause the machine and/or computer to perform operations that include receiving a first input including a first set of economic sectors in a geographical region. The operations further include retrieving first emission data associated with the second set of economic sectors. The first emission data indicates an emission of a set of pollutants by each economic sector of the second set of economic sectors. Further, the first emission data is retrieved from one or more databases. The operations further include generating a first set of knowledge graphs based on the first set of economic sectors. The operations further include generating a second set of knowledge graphs based on the second set of economic sectors. The operations further include harmonizing the first set of economic sectors with the second set of economic sectors based on the first set of knowledge graphs and the second set of knowledge graphs. Additionally, the operations further include generating second emission data based on the harmonization of the first set of economic sectors with the second set of economic sectors. The generated second emission data is indicative of harmonized emission data of the second set of economic sectors. The operations further include rendering the generated second emission data.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a computer, a first input comprising a first set of economic sectors in a geographical region;
retrieving, by the computer, first emission data associated with a second set of economic sectors, wherein the first emission data indicates an emission of a set of pollutants by each economic sector of the second set of economic sectors, and wherein the first emission data is retrieved from one or more databases;
generating, by the computer, a first set of knowledge graphs based on the first set of economic sectors;
generating, by the computer, a second set of knowledge graphs based on the second set of economic sectors;
harmonizing, by the computer, the first set of economic sectors with the second set of economic sectors based on the first set of knowledge graphs and the second set of knowledge graphs;
generating, by the computer, second emission data based on the harmonization of the first set of economic sectors with the second set of economic sectors, wherein the second emission data is indicative of harmonized emission data of the second set of economic sectors; and
rendering, by the computer, the generated second emission data.

2. The computer-implemented method of claim 1, wherein one or more economic sectors of the first set of economic sectors correspond to an economic sector of the second set of economic sectors.

3. The computer-implemented method of claim 1, wherein one or more economic sectors of the second set of economic sectors correspond to an economic sector of the first set of economic sectors.

4. The computer-implemented method of claim 1, further comprising:
identifying, by the computer, one or more missing values in a first emission table based on the retrieval of the first emission data, wherein the first emission data comprises the first emission table;
determining, by the computer, a set of clusters based on the identification of the one or more missing values, wherein each cluster of the set of clusters is associated with at least one of the geographical region, a time period, or a subset of economic sectors of the second set of economic sectors; and
determining, by the computer, the one or more missing values based on the set of clusters.

5. The computer-implemented method of claim 4, further comprising:
generating, by the computer, a set of graph data structures based on the set of clusters; and
generating, by the computer, a graph embedding vector for each graph data structure of the set of graph data structures.

6. The computer-implemented method of claim 5, further comprising:
retrieving, by the computer, contextual data associated with the second set of economic sectors in the geographical region;
determining, by the computer, a feature representation for each graph data structure of the set of graph data structures based on the contextual data and the set of clusters;
tuning, by the computer, a graph-based foundation model based on the determined feature representation for each graph data structure of the set of graph data structures and the generated graph embedding vector for each graph data structure of the set of graph data structures, wherein the graph-based foundation model analyzes at least one of a spatial relationship, a temporal relationship, or a sectoral relationship of the set of pollutants by each economic sector of the second set of economic sectors; and
determining, by the computer, the one or more missing values in the first emission table based on the tuning of the graph-based foundation model.

7. The computer-implemented method of claim 6, wherein the contextual data comprises at least one of economic indicator data of the geographical region, demographic indicator data of the geographical region, or social indicator data of the geographical region.

8. The computer-implemented method of claim 4, further comprising:
extracting, by the computer, a set of features from the first emission data based on the identification of the one or more missing values, wherein the set of features comprises at least one of spatial features, temporal features, or sectoral features associated with each economic sector of the second set of economic sectors; and
determining, by the computer, the set of clusters based on the extracted set of features.

9. The computer-implemented method of claim 1, further comprising:
generating, by the computer, a first set of embedding vectors based on the first set of knowledge graphs;
generating, by the computer, a second set of embedding vectors based on the second set of knowledge graphs; and
harmonizing, by the computer, the first set of economic sectors with the second set of economic sectors based on the first set of embedding vectors and the second set of embedding vectors.

10. The computer-implemented method of claim 9, further comprising:
aggregating, by the computer, the first set of embedding vectors and the second set of embedding vectors;
generating, by the computer, a third set of embedding vectors based on the aggregation of the first set of embedding vectors and the second set of embedding vectors;
disaggregating, by the computer, the third set of embedding vectors;
generating, by the computer, a fourth set of embedding vectors based on the disaggregation of the third set of embedding vectors; and
harmonizing, by the computer, the first set of economic sectors with the second set of economic sectors based on the generated fourth set of embedding vectors.

11. The computer-implemented method of claim 1, further comprising:
determining, by the computer, a first economic sector of the first set of economic sectors is unharmonized with at least one economic sector of the second set of economic sectors;
executing, by the computer, a reverse mapping of the first economic sector with the at least one economic sector based on the determination that the first economic sector is unharmonized with the at least one economic sector of the second set of economic sectors;
harmonizing, by the computer, the first economic sector with the at least one economic sector of the second set of economic sectors based on the reverse mapping; and
generating, by the computer, the second emission data based on the harmonization of the first economic sectors with the at least one economic sector of the second set of economic sectors.

12. The computer-implemented method of claim 1, further comprising:
receiving, by the computer, input-output data associated with the geographical region, wherein the input-output data comprises at least one of resource input information, output production information, or inter-industry exchange information associated with each economic sector of the second set of economic sectors; and
generating, by the computer, the second emission data based on the input-output data associated with the geographical region and the harmonization of the first set of economic sectors with the second set of economic sectors.

13. The computer-implemented method of claim 1, further comprising generating, by the computer, the first set of knowledge graphs based on an application of one or more natural language processing (NLP) techniques on the first input.

14. A computer system, comprising:
a processor set;
one or more computer-readable storage media; and
program instructions stored on the one or more computer-readable storage media, the program instructions executable by the processor set to cause the processor set to:
receive a first input comprising a first set of economic sectors in a geographical region;
retrieve first emission data associated with a second set of economic sectors, wherein the first emission data indicates an emission of a set of pollutants by each economic sector of the second set of economic sectors, and wherein the first emission data is retrieved from one or more databases;
generate a first set of embedding vectors based on the reception of the first input;
generate a second set of embedding vectors based on the retrieval of the first emission data;
harmonize the first set of economic sectors with the second set of economic sectors based on the first set of embedding vectors and the second set of embedding vectors;
generate second emission data based on the harmonization of the first set of economic sectors with the second set of economic sectors, wherein the generated second emission data is indicative of harmonized emission data of the second set of economic sectors; and
render the generated second emission data.

15. The computer system of claim 14, wherein the program instructions further cause the processor set to:
identify one or more missing values in a first emission table based on the retrieval of the first emission data, wherein the first emission data comprises the first emission table;
determine a set of clusters based on the identification of the one or more missing values, wherein each cluster of the set of clusters is associated with at least one of the geographical region, a time period, or a subset of economic sectors of the second set of economic sectors; and
determine the one or more missing values based on the set of clusters.

16. The computer system of claim 15, wherein the program instructions further cause the processor set to:
generate a set of graph data structures based on the set of clusters; and
generate a graph embedding vector for each graph data structure of the set of graph data structures.

17. The computer system of claim 16, wherein the program instructions further cause the processor set to:
retrieve contextual data associated with the second set of economic sectors in the geographical region;
determine a feature representation for each graph data structure of the set of graph data structures based on the contextual data and the set of clusters;
tune a graph-based foundation model based on the determined feature representation for each graph data structure of the set of graph data structures and the generated graph embedding vector for each graph data structure of the set of graph data structures, wherein the graph-based foundation model analyzes at least one of a spatial relationship, a temporal relationship, or a sectoral relationship of the set of pollutants by each economic sector of the second set of economic sectors; and
determine the one or more missing values in the first emission table based on the tuned graph-based foundation model.

18. The computer system of claim 14, wherein the program instructions further cause the processor set to:
generate a first set of knowledge graphs based on the first set of economic sectors;
generate the first set of embedding vectors based on the first set of knowledge graphs;
generate a second set of knowledge graphs based on the second set of economic sectors; and
generate the second set of embedding vectors based on the second set of knowledge graphs.

19. The computer system of claim 14, wherein the program instructions further cause the processor set to:
aggregate the first set of embedding vectors and the second set of embedding vectors;
generate a third set of embedding vectors based on the aggregation of the first set of embedding vectors and the second set of embedding vectors;
disaggregate the third set of embedding vectors;
generate a fourth set of embedding vectors based on the disaggregation of the third set of embedding vectors; and
harmonize the first set of economic sectors with the second set of economic sectors based on the generated fourth set of embedding vectors.

20. A computer-program product for generating emission data, the computer-program product comprising:
one or more computer-readable storage media; and
program instructions stored on the one or more computer-readable storage media to perform operations comprising:
receiving a first input that comprises a first set of economic sectors in a geographical region;
retrieving first emission data associated with a second set of economic sectors, wherein the first emission data indicates an emission of a set of pollutants by each economic sector of the second set of economic sectors, and wherein the first emission data is retrieved from one or more databases;
generating a first set of knowledge graphs based on the first set of economic sectors;
generating a second set of knowledge graphs based on the second set of economic sectors;
harmonizing the first set of economic sectors with the second set of economic sectors based on the first set of knowledge graphs and the second set of knowledge graphs;
generating second emission data based on the harmonization of the first set of economic sectors with the second set of economic sectors, wherein the generated second emission data is indicative of harmonized emission data of the second set of economic sectors; and
rendering the generated second emission data.
